(19) United States
(12) Patent Application Publication
(10) Pub. No.: US 2026/0244562 A1
(43) Pub. Date: Aug. 20, 2026

(54) SYSTEM AND METHOD FOR LARGE-SCALE LOW-LATENCY LANGUAGE-MODEL DEPLOYMENTS USING DYNAMIC HIERARCHICAL STORAGE AND GPU OPTIMIZATION

(71) Applicant: VINAY JAYANNA, Seattle, WA (US)

(72) Inventor: VINAY JAYANNA, Seattle, WA (US)

(21) Appl. No.: 19/055,731

(22) Filed: Feb. 18, 2025

(51) Int. Cl. G06F 12/02

(52) U.S. Cl. CPC G06F 12/023

(57) ABSTRACT

Exemplary embodiments of present disclosure are directed towards system and method for large-scale low-latency language-model deployments using dynamic hierarchical storage and GPU optimization. System introduces a dynamic hierarchical storage architecture with hot, warm, and cold tiers optimized for large-scale LLMs, enabling significant reductions in cold-start latency to sub-human perception thresholds. GPU allocation mechanism dynamically assigns and reclaims GPU resources across thousands of models based on real-time traffic patterns, reducing idle time, operational costs. System integrates predictive preloading, leveraging historical and real-time traffic data to prioritize and preload high-demand models into high-speed storage tiers, ensuring immediate responsiveness. Inference optimization further accelerates repetitive queries by avoiding redundant computations, while an intelligent traffic-aware scheduler maximizes GPU utilization across diverse workloads. This invention is tailored for AI marketplaces and domain-specific LLMs across industries, enabling unparalleled scalability and responsiveness. System addresses critical challenges of scalability, cost efficiency, accessibility, and environmental impact in large-scale AI deployments.

### COPYRIGHT AND TRADEMARK NOTICE

This application includes material which is subject or may be subject to copyright and/or trademark protection. The copyright and trademark owner(s) have no objection to the facsimile reproduction by any of the patent disclosure, as it appears in the Patent and Trademark Office files or records, but otherwise reserves all copyright and trademark rights whatsoever.

### TECHNICAL FIELD

The present disclosure generally relates to the field of artificial intelligence (AI) infrastructure and resource management. More particularly, the present disclosure relates to a system and method for deploying and managing large-scale language model marketplace deployments with minimized cold-start latency through dynamic hierarchical storage and GPU optimization. The present disclosure encompasses technologies for dynamic hierarchical storage, GPU allocation, predictive resource scaling, and latency optimization in cloud-based and distributed computing environments. Additionally, the present disclosure addresses challenges in scalability, cost-efficiency, and responsiveness for AI inference workflows in high-demand applications, including AI marketplaces, enterprise solutions, and real-time decision-making systems.

### BACKGROUND

The rapid advancements in artificial intelligence (AI) have led to the proliferation of large-scale AI models, particularly Large Language Models (LLMs). These models, due to their size and computational requirements, pose significant challenges in deployment, scalability, and operational efficiency. Traditional AI model deployment platforms struggle to meet the unique demands of these models, leading to inefficiencies and high operational costs.

Deploying and serving large AI models requires substantial computational resources, particularly GPUs, which are expensive to operate and maintain. The need to keep GPUs continuously running for thousands of models, many of which may experience sparse or unpredictable traffic, becomes cost-prohibitive for enterprises and startups alike. Static resource allocation exacerbates this issue by failing to optimize GPU utilization. One of the most critical challenges in serverless AI model deployment is the latency caused by cold starts. When traffic triggers the deployment of a model, it must first be downloaded from cold storage (e.g., AWS S3) to high-speed storage or memory. This process introduces delays that severely impact user experience, particularly in real-time inference scenarios.

AI models often experience sporadic traffic patterns, yet traditional deployment platforms allocate resources as if demand were constant. This results in significant inefficiencies, with idle GPUs and other resources consuming energy and incurring unnecessary costs. The deployment of LLMs presents unique scalability challenges. Their large size, high resource demands, and the need to maintain low-latency responses for end users make them difficult to serve in traditional architectures. Existing solutions fall short in providing a scalable framework capable of managing thousands of concurrent models while ensuring efficient resource utilization.

Existing approaches to AI model deployment fail to adequately address these challenges. Serverless computing platforms (e.g., AWS Lambda, Azure Functions) are optimized for lightweight, stateless functions and struggle to handle the high resource demands of LLMs. Long cold-start latencies and the inability to manage GPUs effectively make these solutions unsuitable for large-scale AI workloads. Traditional AI model deployment platforms (e.g., AWS SageMaker, Google Vertex AI) rely on always-on infrastructure, which is cost-intensive and impractical for sparsely accessed models. General-purpose caching solutions (e.g., Redis, Memcached) are not designed to handle the unique requirements of storing and managing Large Language Models (LLMs), which often exceed 20 GB in size. These systems are primarily optimized for lightweight key-value pairs of small size (typically in KBs or less) and are practically infeasible for handling the hierarchical storage and retrieval needs of LLMs, such as dynamic promotion and eviction across high-speed caches and cold storage tiers. Static scaling approaches fail to adapt to fluctuating traffic patterns, leading to resource wastage and an inability to efficiently handle sudden demand spikes.

The limitations of existing systems manifest in several critical ways: Cold start latency: Traditional architectures introduce significant delays when loading large AI models from storage, making them unsuitable for real-time inference. Resource Wastage: Always-on infrastructure results in substantial operational inefficiencies for infrequently used models. High Operational Costs: Continuous GPU availability for hosting LLMs leads to unsustainable expenses, particularly for large-scale deployments. Limited Scalability: Current solutions lack dynamic caching and GPU sharing tailored to the specific needs of AI workloads. Insufficient Integration of AI-Specific Caching: Existing caching systems do not address the unique challenges posed by large model sizes, frequent updates, and memory-intensive tasks.

In the light of the aforementioned discussion, there exists a need for a system with novel methodologies that would overcome the above-mentioned challenges.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Exemplary embodiments of the present disclosure are directed towards a system and method for large-scale low-latency language-model deployments using dynamic hierarchical storage and GPU optimization.

An objective of the present disclosure is directed towards optimizing resource utilization in AI model serving environments through a traffic-aware system that dynamically adapts to real-time and historical usage patterns.

Another objective of the present disclosure is directed towards a system that implements a multi-tiered storage mechanism to efficiently store and retrieve AI models. Frequently accessed models are cached on high-speed storage layers, while rarely used models are moved to persistent storage, ensuring cost-effective resource management.

Another objective of the present disclosure is directed towards a system that employs a dynamic eviction mechanism to transfer models from high-speed storage to persistent storage based on diminished traffic, maintaining optimal resource utilization without affecting performance.

Another objective of the present disclosure is directed towards a system that incorporates preemptive model loading based on traffic prediction algorithms, enabling models to be proactively loaded into high-speed storage before traffic surges, thus reducing cold start latency.

Another objective of the present disclosure is directed towards a system that utilizes historical and real-time traffic data to predict demand patterns, thereby proactively managing storage and compute resources to enhance performance and responsiveness.

Another objective of the present disclosure is directed towards reducing cold start latency by preemptively reloading models in anticipation of traffic spikes, ensuring minimal delays and enhanced user experience.

Another objective of the present disclosure is directed towards achieving cost-efficiency in AI model hosting by dynamically allocating storage and compute resources, particularly in serverless AI environments and large-scale enterprise workloads.

Another objective of the present disclosure is directed towards a system that provides scalability for managing large-scale AI workloads, making it applicable to serverless AI environments and cloud-based enterprise infrastructures.

Another objective of the present disclosure is directed towards maintaining high performance and availability in AI model serving systems by balancing resource efficiency with the need for consistent model accessibility during fluctuating traffic conditions.

Another objective of the present disclosure is directed towards a system that dynamically caches frequently accessed models in high-speed storage, such as parallel distributed file systems (Apache Lustre), ensuring minimal loading time during traffic spikes and significantly reducing cold start latency.

Another objective of the present disclosure is directed towards optimizing GPU utilization by combining serverless principles with traffic-based caching, allowing multiple AI models to share GPU resources rather than requiring dedicated GPUs for each model.

Another objective of the present disclosure is directed towards a system that implements a multi-tier eviction process, seamlessly moving less frequently used models from high-speed caches to cold storage and reloading them when traffic increases, thereby balancing cost-efficiency and responsiveness.

Another objective of the present disclosure is directed towards a system that leverages traffic prediction algorithms to preemptively load AI models into memory or high-speed caches before anticipated traffic spikes, further mitigating cold start latency.

Another objective of the present disclosure is directed towards a serverless AI framework that enables large-scale deployment of LLMs and other resource-intensive models by dynamically scaling GPUs and computing resources based on traffic patterns, eliminating the need for always-on infrastructure and reducing operational costs.

Another objective of the present disclosure is directed towards enabling cost-efficient GPU sharing across thousands of AI models by dynamically scaling resources based on traffic patterns, eliminating the need for always-on infrastructure.

Another objective of the present disclosure is directed towards reducing energy consumption by optimizing GPU usage and avoiding idle or underutilized infrastructure, ensuring sustainable and efficient resource allocation.

Another objective of the present disclosure is directed towards lowering the carbon footprint associated with maintaining always-on GPU servers by dynamically scaling resources to match demand, promoting environmentally sustainable AI operations.

Another objective of the present disclosure is directed towards a traffic-aware serverless AI model deployment system that mitigates cold start latency, reduces GPU costs, and improves resource efficiency through a combination of hierarchical model caching, predictive traffic analysis, and dynamic resource allocation.

Another objective of the present disclosure is directed towards a system designed to handle large-scale AI workloads, including large language models (LLMs) and deep learning models, across multiple AI frameworks such as TensorFlow, PyTorch, and Hugging Face.

Another objective of the present disclosure is directed towards a three-tier caching system optimized for AI workloads, ensuring minimal cold-start latency even for resource-intensive models by dynamically managing model placement across high-speed, medium-speed, and cold storage tiers.

Another objective of the present disclosure is directed towards the efficient sharing of GPU resources across multiple AI models, reducing operational costs while maintaining high-performance inference capabilities.

Another objective of the present disclosure is directed towards a system that employs advanced traffic prediction algorithms to proactively load models into high-speed storage, minimizing cold start latency in serverless AI model deployments.

Another objective of the present disclosure is directed towards combining serverless architecture, hierarchical caching, and dynamic scaling mechanisms into a single, integrated platform tailored specifically for AI workloads.

Another objective of the present disclosure is directed towards a system designed to handle large-scale models, such as LLMs, which require significant memory and computational resources, ensuring scalability and efficiency.

Another objective of the present disclosure is directed towards reducing cold start times by up to 90% through the use of hierarchical caching mechanisms, achieving latency reductions from approximately 300 seconds to within 30 seconds.

Another objective of the present disclosure is directed towards reducing GPU idle time by up to 70% through dynamic GPU sharing, enabling significant cost savings while maintaining operational efficiency.

Another objective of the present disclosure is directed towards a system capable of scaling to handle thousands of AI models simultaneously, with negligible overhead even during peak traffic conditions.

Another objective of the present disclosure is directed towards ensuring a seamless user experience during traffic spikes by leveraging predictive preloading, resulting in no noticeable delays in model execution.

Another objective of the present disclosure is directed towards validating the system's effectiveness in real-world scenarios, including LLMs, real-time predictions, and resource-intensive models, specifically in educational and enterprise environments.

Another objective of the present disclosure is directed towards reducing GPU infrastructure costs by over 50% compared to traditional AI model deployment platforms through traffic-aware scaling, GPU sharing, and hierarchical caching mechanisms.

Another objective of the present disclosure is directed towards minimizing cold start latency by up to 90% using predictive preloading, hierarchical caching, and inference caching, ensuring a seamless real-time AI model serving for end-users.

Another objective of the present disclosure is directed towards enabling the platform to efficiently manage thousands of simultaneous AI models, including resource-intensive models like LLMs, with dynamic resource scaling.

Another objective of the present disclosure is directed towards supporting low-latency deployment for complex AI models across frameworks such as TensorFlow, PyTorch, and Hugging Face, ensuring compatibility and high-speed inference.

Another objective of the present disclosure is directed towards enhancing user experience during traffic spikes through predictive preloading, ensuring consistent real-time AI model execution.

Another objective of the present disclosure is directed towards eliminating resource wastage through GPU sharing and hierarchical caching, ensuring optimal hardware utilization while reducing operational costs.

Another objective of the present disclosure is directed towards democratizing

AI technologies by making high-performance model serving affordable, scalable, and accessible to small organizations, startups, and educational institutions.

Another objective of the present disclosure is directed towards a predictive traffic-aware serverless system that dynamically scales resources based on real-time and forecasted demand, reducing idle GPU costs and latency.

Another objective of the present disclosure is directed towards a three-tier hierarchical caching mechanism that optimizes access to AI models, preventing bottlenecks during high-traffic periods.

Another objective of the present disclosure is directed towards dynamically sharing GPUs among active models, reducing underutilized resources and drastically lowering operational costs.

Another objective of the present disclosure is directed towards handling large models such as LLMs through specialized caching and scaling mechanisms designed to manage high memory and compute requirements.

Another objective of the present disclosure is directed towards providing a comprehensive platform that streamlines the AI model lifecycle, from training and deployment to inference and evaluation, within a unified system.

Another objective of the present disclosure is directed towards introducing inference caching to accelerate repetitive queries, reducing compute load and inference latency.

Another objective of the present disclosure is directed towards anticipating traffic spikes using advanced algorithms and preloading models into high-speed caches for immediate readiness.

Another objective of the present disclosure is directed towards offering adaptability for a range of deployments, from educational institutions to enterprise-scale systems, across on-premise, multi-cloud, or hybrid environments.

Another objective of the present disclosure is directed towards supporting domain-specific AI applications in sectors such as healthcare, finance, retail, and autonomous systems by providing tailored deployment capabilities.

Another objective of the present disclosure is directed towards enabling low-latency AI applications like chatbots, recommendation systems, and sentiment analysis, crucial for industries requiring immediate responses.

Another objective of the present disclosure is directed towards reducing the environmental impact of AI operations through optimized resource usage, minimizing energy consumption, and supporting greener AI infrastructure.

Another objective of the present disclosure is directed towards tailoring AI solutions for emerging sectors such as agriculture and energy, enabling applications like crop yield prediction and renewable energy optimization.

Another objective of the present disclosure is directed towards enabling federated learning frameworks through secure deployment and inference of models across decentralized data sources, ensuring data privacy and security.

Another objective of the present disclosure is directed towards creating an AI marketplace for model monetization and talent discovery by showcasing live models and enabling practical skill assessments.

According to an exemplary aspect of the present disclosure, a computing device comprising a processor for executing instructions from an inference request module located within the computing device, wherein the inference request module configured to receive inference requests for one or more Large Language Models (LLMs), wherein each inference request includes input parameters and a target model identifier, the inference request module transmit the inference requests to a cloud server over a network based on traffic conditions and predefined service-level agreements (SLAs).

According to another exemplary aspect of the present disclosure, the cloud server comprises a hierarchical storage and resource allocation module configured to manage the placement and retrieval of one or more Large Language Models (LLMs) across a hierarchical storage system comprising a hot storage configured to store frequently accessed models on high-speed, low-latency local storage devices such as NVMe SSDs, a warm storage configured to store moderately accessed models on high-speed network-attached storage, and a cold storage configured to store infrequently accessed models on cost-efficient object storage systems such as AWS S3 or Google Cloud Storage.

According to another exemplary aspect of the present disclosure, the hierarchical storage and resource allocation module is configured to promote models dynamically from lower-tier storage (Cold or Warm Storage) to higher-tier storage (Warm or Hot Storage) based on real-time traffic patterns and predicted demand and allocate computational resources, including GPUs, for inference tasks associated with the LLMs, wherein resource allocation is dynamically adjusted to meet active workload demands.

According to another exemplary aspect of the present disclosure, a traffic analyzer operatively coupled to the inference request module and the hierarchical storage and resource allocation module, wherein the traffic analyzer is configured to monitor and analyze real-time traffic patterns and historical usage data to predict demand for specific LLMs, whereby the traffic analyzer configured to trigger the preloading of high-demand models into Hot Storage or Warm Storage tiers to minimize cold-start latency.

According to another exemplary aspect of the present disclosure, a GPU orchestrator operatively coupled to the hierarchical storage and resource allocation module, whereby the GPU orchestrator is configured to assign GPU resources dynamically to active inference tasks based on model priorities and real-time demand and deallocate GPU resources from idle and low-priority tasks to reduce idle GPU time and optimize resource utilization, wherein the hierarchical storage and resource allocation module configured to demote models from higher-tier storage to lower-tier storage based on predefined inactivity thresholds and ensure optimal utilization of storage tiers by freeing up high-speed storage for active and high-priority models.

According to another exemplary aspect of the present disclosure, the hierarchical storage and resource allocation module comprises a clean-up agent configured to periodically remove unused models from storage tiers to free up space for incoming models, ensuring sustained operational efficiency, thereby minimizing cold-start latency for LLMs to under 5 seconds through predictive preloading and hierarchical storage management and optimizing GPU utilization by dynamically reallocating resources based on real-time traffic patterns.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1A illustrates a prior art system for handling user or API requests for data objects based on their size and access frequency, in accordance with one or more exemplary embodiments.

FIG. 1B is an example diagram depicting a comparative analysis of existing AI model deployment systems against the proposed hierarchical storage and GPU sharing system tailored for Large Language Models (LLMs), in accordance with one or more exemplary embodiments.

FIG. 2 is a block diagram depicting a schematic representation of a system for large-scale low-latency language-model deployments using dynamic hierarchical storage and GPU optimization, in accordance with one or more exemplary embodiments.

FIG. 3 is a block diagram depicting an embodiment of the inference request module, in accordance with one or more exemplary embodiments.

FIG. 4 is a block diagram depicting an embodiment of the hierarchical storage and resource allocation module, in accordance with one or more exemplary embodiments.

FIG. 5 is a block diagram depicting a system architecture designed to facilitate efficient and scalable deployment of Large Language Models (LLMs), in accordance with one or more exemplary embodiments.

FIG. 6 is a block diagram depicting a storage flow architecture to facilitate efficient and scalable deployment of Large Language Models (LLMs), in accordance with one or more exemplary embodiments.

FIG. 7 is a block diagram depicting a GPU sharing workflow for dynamically managing GPU resources in real-time to support inference servers hosting Large Language Models (LLMs), in accordance with one or more exemplary embodiments.

FIG. 8 is a block diagram depicting Cold-Start Latency Optimization mechanisms, in accordance with one or more exemplary embodiments.

FIG. 9 is a block diagram depicting a hierarchical storage architecture for efficiently managing the storage and retrieval of Large Language Models (LLMs) across multiple storage tiers, in accordance with one or more exemplary embodiments.

FIG. 10 is a block diagram depicting a hierarchical AI model caching system and its integration with predictive preloading, GPU allocation, inference optimization, and clean-up mechanisms to enhance the efficiency of serving Large Language Models (LLMs), in accordance with one or more exemplary embodiments.

FIG. 11 is an example diagram depicting a Cold-Start Latency Comparison across the hierarchical storage tiers Hot Storage, Warm Storage, and Cold Storage, in accordance with one or more exemplary embodiments.

FIG. 12 is an example diagram depicting a tabular comparison of the performance and resource utilization between static and dynamic GPU allocation approaches for deploying Large Language Models (LLMs).

FIG. 13 is an example diagram depicting a graphical representation of GPU utilization under static and dynamic deployment methods for managing LLM inference workloads over a 21-hour period, in accordance with one or more exemplary embodiments.

FIG. 14 is a flow diagram depicting a method for managing inference requests and resource allocation for Large Language Models (LLMs) using a hierarchical caching system, in accordance with one or more exemplary embodiments.

FIG. 15 is a flow diagram depicting a method for managing and serving Large Language Models (LLMs) using a hierarchical storage system, in accordance with one or more exemplary embodiments.

FIG. 16 is a flow diagram depicting a method for dynamically managing GPU resources for inference servers hosting large language models (LLMs), in accordance with one or more exemplary embodiments.

FIG. 17 is a flow diagram depicting a method for optimizing latency in large-scale deployments of Large Language Models (LLMs), in accordance with one or more exemplary embodiments.

FIG. 18 is a flow diagram depicting a method for managing the storage and retrieval of Large Language Models (LLMs) across a hierarchical storage architecture), in accordance with one or more exemplary embodiments.

FIG. 19 is a block diagram illustrating the details of a digital processing system in which various aspects of the present disclosure are operative by execution of appropriate software instructions.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another.

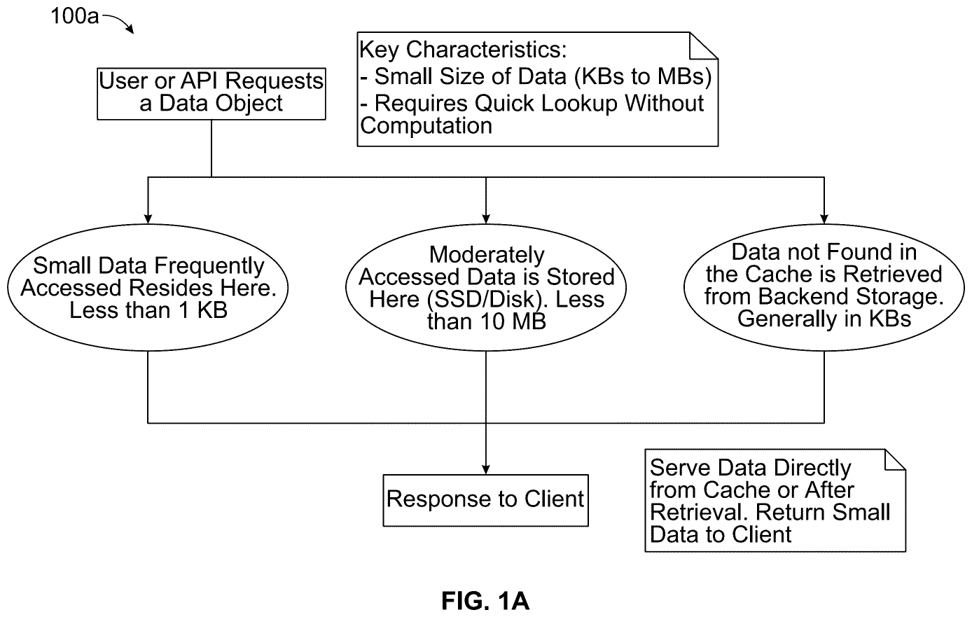

Referring to FIG. 1A provides a schematic representation of a traditional hierarchical data management workflow 100a designed to efficiently handle user or API requests for data objects. The system 100a is structured to optimize retrieval speed by categorizing data based on its size and access frequency, thereby ensuring quick lookups and efficient storage utilization. At the entry point of the system 100a, a user or API request for a data object is initiated. This request triggers a decision-making process within the system 100a to determine the optimal storage tier from which the requested data can be retrieved. The workflow is governed by the following tiers: Small Data Frequently Accessed (Cache Layer): Data objects with sizes less than 1 KB and high access frequency are stored in a cache layer designed for ultra-low latency retrieval. This layer is optimized for immediate lookups and caters to data requiring frequent access without additional computation. By prioritizing such data in high-speed memory, the system minimizes retrieval latency, ensuring quick responses for high-priority requests. Moderately Accessed Data (Intermediate Storage): Moderately accessed data, typically ranging in size up to 10 MB, is stored on SSDs or high-speed disks. This tier balances storage speed and capacity, providing slightly higher latency compared to the cache layer. When a requested data object resides in this layer, it is fetched and processed before being delivered to the client. The intermediate storage serves as a buffer between the cache and backend storage, optimizing access for data with medium-level demand. Backend Storage (Cold Layer): Data not found in the cache or intermediate storage is retrieved from backend storage systems, such as object storage. This layer is designed for cost-efficient long-term storage of rarely accessed data, typically in smaller sizes (e.g., KBs). Although retrieval latency is higher, the backend layer ensures all requested data objects are accessible. The system 100a incorporates a dynamic retrieval mechanism: If the requested data is located in the cache or intermediate storage, it is fetched and directly served to the client. For data not found in these layers, the system queries the backend storage, retrieves the object, and delivers it to the client after processing. Finally, the system ensures efficient data delivery by serving the requested data object from the most appropriate storage tier. The hierarchical approach minimizes latency for frequently accessed data while maintaining cost efficiency for less accessed or larger data objects. The workflow highlights the limitations of traditional systems in handling dynamic data demands, such as cold-start scenarios or predictive scaling, which are addressed in modern hierarchical systems.

In accordance with one or more exemplary embodiments of the present disclosure, the traditional hierarchical data management workflow is a system 100a meticulously crafted to handle user or API requests for data objects with efficiency. This system categorizes data based on size and access frequency, creating a tiered structure that ensures quick retrieval and optimal storage utilization. While this approach has proven effective for general-purpose data, its design falls short when confronted with the unique demands of modern AI workloads, particularly those involving Large Language Models (LLMs) and AI model inference engines like TorchServe or Triton Server. At its core, the traditional workflow starts with a user or API request for a data object, triggering a decision-making process to determine the appropriate storage tier for retrieval. The system operates across three main layers: a cache layer for frequently accessed small data, an intermediate layer for moderately accessed data, and a backend storage layer for rarely accessed data. Each tier is optimized for specific use cases, with the cache layer offering ultra-low latency for data less than 1 KB, the intermediate layer serving as a buffer for data up to 10 MB, and the backend storage providing cost-effective storage for less accessed data. However, this approach reveals profound limitations when applied to the storage and retrieval needs of LLMs, which often range from 20 GB to 1 TB in size. The first and most glaring limitation is the incompatibility of traditional systems with the massive scale of LLMs. Cache layers, typically implemented with high-speed memory like DRAM, are designed to store small data objects for immediate retrieval. These layers are fundamentally incapable of accommodating even a fraction of an LLM, rendering them ineffective for AI inference workloads. Similarly, intermediate storage tiers, while larger in capacity, are optimized for moderately sized objects and fail to offer the throughput required to handle multi-GB LLMs. Even the backend storage, designed for rarely accessed data, struggles with the high retrieval latencies and bandwidth constraints that arise when serving large models during inference. Another critical limitation lies in the system's inability to address cold-start latency, a defining challenge in AI inference. Traditional workflows are not designed to proactively preload high-priority models into faster storage tiers, leaving users to face significant delays when models must be retrieved from backend storage. The absence of predictive preloading mechanisms exacerbates these delays, making traditional systems unsuitable for high-demand AI applications where milliseconds of latency can disrupt the user experience. The limitations extend further when considering the requirements of modern AI inference engines. Tools like TorchServe and Triton Server require dynamic storage management to load and unload models in response to real-time traffic. Traditional caching systems lack the intelligence to handle such dynamic model lifecycles, leading to inefficiencies in resource utilization and bottlenecks in serving real-time inference requests. Moreover, these systems are ill-equipped to optimize GPU workloads, which are critical for AI inference. GPUs demand high I/O throughput and low-latency access, but traditional systems fail to provide the necessary infrastructure, resulting in underutilized GPUs and increased operational costs. The scalability of traditional systems is yet another area of concern. These systems are designed for general-purpose use cases and struggle to scale effectively for large-scale AI marketplaces managing thousands of concurrent models. Without the ability to dynamically allocate GPUs or manage hierarchical storage intelligently, the ratio of GPUs to models remains unsustainably high. For instance, an AI marketplace hosting 100,000 models would require a proportional number of GPUs under a traditional system, making the platform financially and operationally infeasible. This inefficiency is compounded by the sporadic nature of traffic in AI workloads, where most models experience bursts of requests followed by long periods of inactivity. Data security and privacy are also inadequately addressed in traditional workflows. AI inference often involves sensitive data and models that demand strict security protocols. Traditional systems lack built-in encryption mechanisms and fine-grained access controls, making them unsuitable for multi-tenant AI marketplaces where data confidentiality is paramount. Finally, traditional workflows fail to leverage inference caching, a technique that dramatically reduces computational overhead for repetitive queries. While these systems excel in static data caching, they are not designed to cache inference results dynamically, leaving a significant opportunity for optimization unaddressed. In conclusion, the traditional data management workflow, while effective for general-purpose use cases, is fundamentally misaligned with the needs of modern AI workloads. Its inability to handle large-scale LLMs, address cold-start latency, optimize GPU utilization, scale dynamically, and ensure data security highlights the necessity of innovative systems tailored specifically for AI marketplaces. These advanced systems must combine scalability, low latency, cost efficiency, and robust security to meet the demands of an AI-driven future.

Referring to FIG. 1B is an example diagram 100b depicting a comparative analysis of existing AI model deployment systems against the proposed hierarchical storage and GPU sharing system tailored for Large Language Models (LLMs), in accordance with one or more exemplary embodiments. It highlights the shortcomings of traditional architectures and demonstrates how the proposed system addresses these challenges to deliver high scalability, low latency, and efficient resource utilization, especially for managing large-scale LLM deployments. Existing systems rely on single-tier caching mechanisms, which store all models in a uniform storage layer, typically based on memory or SSDs. While this approach is sufficient for managing small AI models, typically under 100 MB, it becomes impractical for LLMs, which can range from 20 GB to 50 GB or more. A single-tier caching system lacks the flexibility to adapt to varying access patterns and traffic demands, leading to inefficiencies in both storage utilization and retrieval speed. Retrieval latency becomes untenable for large-scale models, as there is no intermediate mechanism to bridge the gap between cost-efficient storage and high-speed access. The proposed system addresses this limitation by employing a hierarchical storage architecture, which may be configured to include three tiers: hot, warm, and cold storage. Hot storage leverages high-speed NVMe SSDs for sub-second retrieval of frequently accessed models, while warm storage uses SSDs or high-speed distributed file systems for moderately accessed models. Cold storage, based on scalable object storage like AWS S3, ensures cost efficiency for infrequently accessed models. Traditional systems also depend on static GPU allocation, where dedicated GPUs are assigned to specific tasks or models. This approach leads to significant resource wastage, as GPUs remain idle during periods of low activity. Furthermore, static allocation fails to adapt to traffic fluctuations, resulting in underutilized resources during downtime and bottlenecks during traffic spikes. In contrast, the proposed system introduces a traffic-aware GPU sharing mechanism that dynamically allocates resources based on real-time demand. This feature may be configured to enable inference servers to activate or shut down depending on traffic volume, significantly reducing GPU idle time and operational costs. By sharing GPUs across multiple models, the system maximizes utilization, reducing GPU requirements by at least 50% compared to traditional methods.

Scalability is another critical area where traditional systems fall short. Legacy architectures are optimized for small-scale AI applications and struggle to manage thousands of concurrent models, as they lack the mechanisms to dynamically allocate storage and computational resources. The proposed system, on the other hand, is inherently scalable and may be configured to support the deployment of over 100,000 models simultaneously. Its hierarchical storage system and serverless GPU allocation capabilities ensure that resources are dynamically scaled up or down to meet fluctuating workloads, making it suitable for modern AI marketplaces and real-time inference applications. Finally, the proposed system addresses the issue of cold-start latency, which is often neglected in traditional architectures. Existing systems, designed for small AI models, experience minimal cold-start delays due to the compact size of the models. However, for LLMs, loading models from storage into memory can take several minutes, rendering these systems impractical for real-time applications. The proposed system employs predictive preloading and hierarchical caching, which may be configured to analyze traffic patterns and proactively preload high-demand models into high-speed storage tiers. This approach reduces cold-start latency to approximately 5 seconds, ensuring a smooth user experience even during traffic surges. By addressing these critical deficiencies, the proposed system sets a new standard for LLM management in cloud-based AI marketplaces. Its combination of hierarchical storage, traffic-aware GPU sharing, and predictive preloading ensures cost efficiency, low latency, and scalability, enabling the deployment of large-scale AI workloads at an unprecedented scale. This innovation bridges the gap between traditional architectures and the modern demands of AI applications, ensuring robust performance and resource optimization.

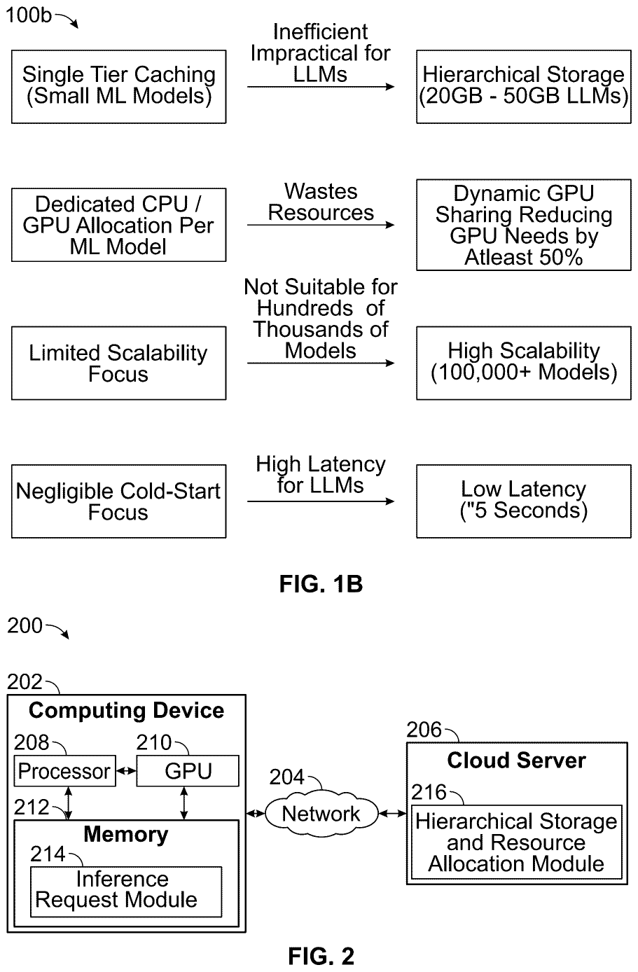

Referring to FIG. 2 is a block diagram 200 depicting a schematic representation of a system for large-scale low-latency language-model deployments using dynamic hierarchical storage and GPU optimization, in accordance with one or more exemplary embodiments. The system 200 includes a computing device 202 a network 204, a cloud server 206, a processor 208, a GPU 210, a memory 212, an inference request module 214, and a hierarchical storage and resource allocation module 216.

The computing device 202 may be configured to act as the user-facing interface, handling input from users and sending requests to the cloud server 206 for AI model inference. It may also process results returned by the cloud server to provide outputs to the end user. The computing device 202 may include the processor 208 may be configured to manage the core computational tasks of the computing device 202. The processor 208 may execute local preprocessing of user inputs, such as tokenizing or formatting data, to ensure compatibility with the AI models deployed on the cloud server 206. Additionally, the processor 208 may coordinate communication with the network 204 to facilitate the transfer of requests and results.

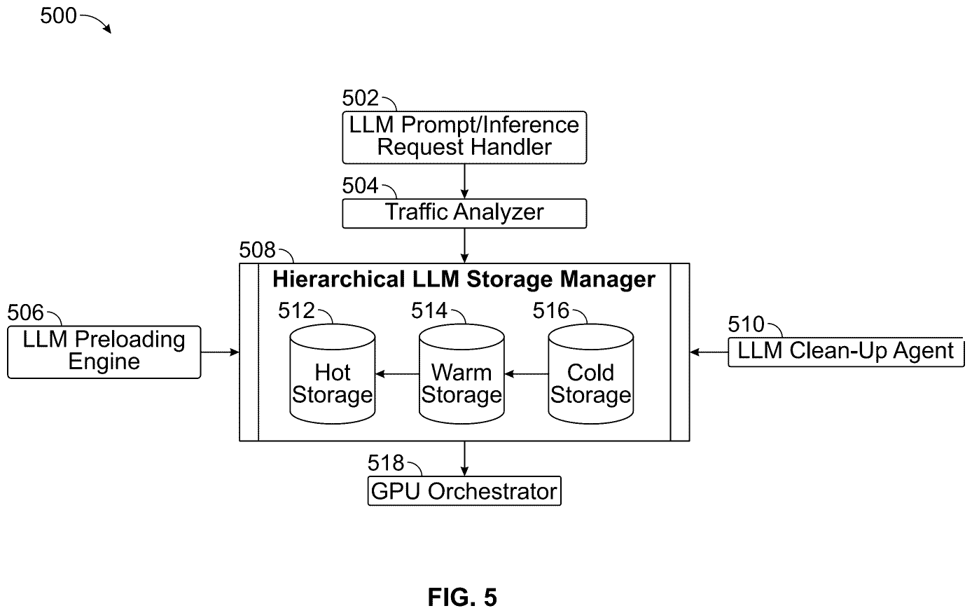

The GPU 210 may be configured to perform lightweight AI computations or inference tasks locally, particularly in scenarios where edge processing is required to reduce latency. The GPU 210 may also support rendering or other graphical tasks depending on the application. The memory 212 may be configured to store temporary data, such as user inputs, inference results, or locally cached models, to enhance performance. For instance, frequently accessed inference results may be cached in memory 212 to reduce redundant network requests. The inference request module 214 may be configured to handle all communication with the cloud server 206. The inference request module 214 may format and send inference requests from the computing device 202 to the cloud server 206. The inference request module 214 may be configured to preprocess input data locally before transmitting it. The inference request module 214 may be configured to receive and process the inference results from the cloud server 206 to make them interpretable for the user or downstream applications. The network 204 may be a communication channel between the computing device 202 and the cloud server 206. It may support protocols to ensure low-latency and high-reliability data exchange, particularly in real-time AI applications. The network 204 facilitates the transfer of inference requests, results, and any intermediate data required for optimized processing. The cloud server 206 may be configured to manage and execute large-scale AI models dynamically. The cloud server 206 may provide the computational backbone for the system and includes several modules that ensure scalability, cost efficiency, and low latency. The cloud server 206 may include the hierarchical storage and resource allocation module 216 may be configured to optimize the storage, retrieval, and execution of AI models. The hierarchical storage and resource allocation module 216 may include several sub-systems. Hierarchical Storage System: The hierarchical Storage system may implement a three-tier storage mechanism: Hot Storage: Stores moderately accessed models on high-speed local storage. Warm Storage: Stores frequently accessed models in ultra-fast memory and parallel distributed file system (e.g., Apache Lustre) to minimize latency. Cold Storage: Stores infrequently accessed models in cost-efficient cloud object storage (e.g., AWS S3, Google Cloud Storage). Models may be dynamically transitioned between these tiers based on their usage patterns, ensuring that high-demand models are readily accessible. The predictive preloading module 406 (as shown in FIG. 4) may be configured to analyze traffic patterns using both real-time and historical data. It may forecast demand spikes and preload high-demand models into the hot cache to mitigate cold start latency. This proactive approach ensures seamless user experience during peak traffic periods. The dynamic resource scaling system may be configured to allocate compute resources, such as GPUs, dynamically. By scaling up or down in response to real-time traffic patterns, this system minimizes idle resources and reduces operational costs. GPU sharing across multiple models is another key feature, allowing efficient utilization of high-cost resources. The inference request module 214 may be configured to store and serve frequently requested inference results. By caching results at the cloud server 206, this module reduces redundant computations and accelerates response times for repetitive queries. The traffic-aware scheduler may be configured to prioritize GPU and computational resources for high-demand workloads while deferring lower-priority tasks. This ensures that critical operations are performed without delay, maximizing GPU utilization across the system. Periodic Clean-Up Agents: These agents may be configured to assess usage patterns periodically and remove unused models from the hot or warm storage. By freeing up space for new high-demand models, these agents maintain optimal storage utilization without requiring manual intervention.

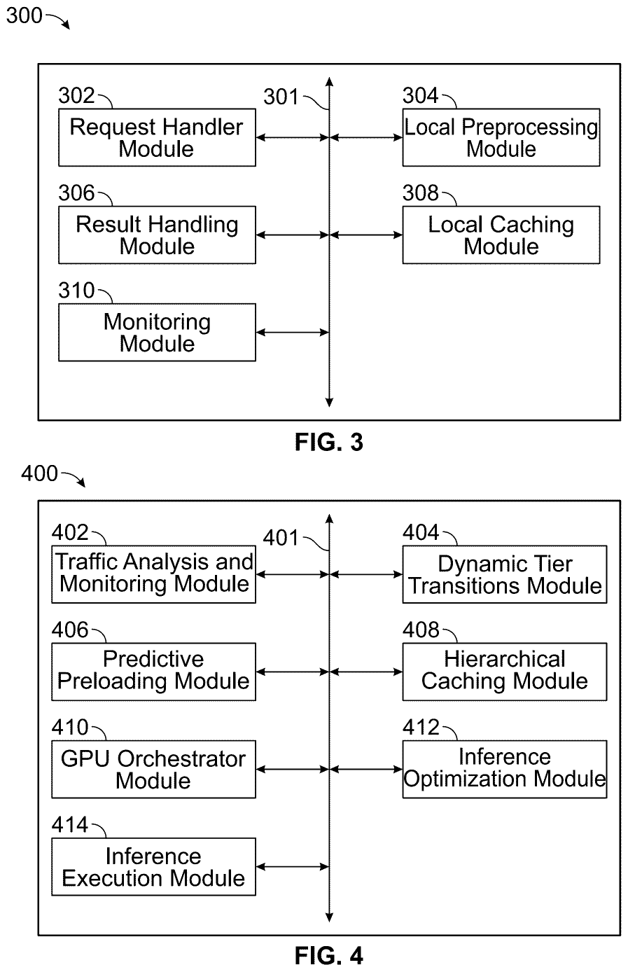

Referring to FIG. 3 is a block diagram 300 depicting an embodiment of the inference request module, in accordance with one or more exemplary embodiments. The inference request module includes a request handler module 302, a local preprocessing module 304, a result handling module 306, a local caching module 308, and a monitoring module 310. The request handler module 302 may be configured to act as the primary interface for receiving inference requests from the user or client applications. It parses the incoming requests to identify the target Large Language Model (LLM), the required parameters, and any associated metadata, such as priority levels or Service Level Agreements (SLAs). The request handler module 302 may also be configured to route the requests to subsequent modules, such as the traffic analysis and monitoring module 402, for further processing. By managing the flow of requests, this module ensures that each request is logged, prioritized, and systematically forwarded for execution. The local preprocessing module 304 may be configured to preprocess the input data locally on the computing device 202 before sending it to the cloud server 206 for inference. This preprocessing may include tokenization, formatting, or embedding input data into a structure compatible with the target LLM. By offloading preprocessing tasks to the local device, this module reduces the computational load on the cloud server 206, improves the efficiency of inference requests, and minimizes latency. The result handling module 306 may be configured to handle and manage the results of inference tasks returned from the cloud server 206. It processes the results to ensure they are formatted appropriately for the end-user application and delivers them back to the user or client system. The result handling module 306 may also be configured to store the results temporarily in the local cache for potential reuse, optimizing response times for repeated or similar requests. The local caching module 308 may be configured to implement a local cache on the computing device 202 to store frequently accessed models or intermediate inference results. This caching mechanism reduces the need to repeatedly query the cloud server 206, thereby minimizing network latency and computational overhead. By prioritizing high-demand models and results, this module ensures fast and efficient handling of repeated user requests. The monitoring module 310 may be configured to observe and log client interactions with the system. The monitoring module 310 monitors metrics such as request frequency, success rates, and latency, enabling the system to adapt dynamically to client needs and maintain a high standard of performance.

Referring to FIG. 4 is a block diagram 400 depicting an embodiment of the hierarchical storage and resource allocation module, in accordance with one or more exemplary embodiments. The traffic analysis and monitoring module 402 may be configured to monitor real-time traffic patterns and evaluate historical data to predict future demand for LLMs. The traffic analysis and monitoring module 402 identifies high-demand models and sends proactive signals to the dynamic tier transitions module 404 or the GPU Orchestrator module 410 to allocate resources efficiently. This module ensures that resource allocation is always aligned with current and anticipated traffic requirements, preventing latency during spikes and minimizing resource wastage during low-traffic periods. The dynamic tier transitions module 404 may be configured to automate the movement of LLMs between storage tiers (e.g., hot, warm, and cold storage) based on their access patterns. Models experiencing high access frequencies are promoted to higher-performance storage tiers, while those with reduced access frequencies are demoted to cost-efficient, lower-performance tiers. The dynamic tier transitions module 404 ensures optimal utilization of storage resources, balancing performance and cost efficiency. The predictive preloading module 406 may be configured to proactively load high-priority models from lower-performance storage tiers (e.g., cold storage) into higher-performance tiers (e.g., warm or hot storage) based on traffic forecasts from the traffic analysis and monitoring module 402. This preloading minimizes cold-start latency by ensuring that high-demand models are ready for immediate access during anticipated traffic spikes. The hierarchical caching module 408 may be configured to manage a multi-tiered caching system comprising hot, warm, and cold storage tiers. It ensures that frequently accessed models are placed in high-speed caches for immediate availability, while less frequently accessed models are stored in lower-performance but cost-efficient storage tiers. The hierarchical caching module 408 dynamically manages the transitions between storage tiers to maintain a balance between performance and cost efficiency. The GPU Orchestrator Module 410 may be configured to allocate GPU resources dynamically for executing inference tasks. It assigns GPUs to inference servers hosting specific LLMs based on real-time demand and traffic predictions. The GPU Orchestrator Module 410 also optimizes GPU utilization by sharing resources across multiple models and tasks, reducing idle GPU time and operational costs. The inference optimization module 412 may be configured to implement performance optimization techniques for executing inference tasks. These techniques may include batching requests, minimizing redundant computations, and parallelizing operations to reduce latency and improve throughput. The inference optimization module 412 works in conjunction with the GPU Orchestrator Module 410 to maximize the efficiency of resource usage during inference execution. The inference execution module 414 may be configured to manage the execution of inference requests using preloaded models and allocated resources. The inference execution module 414 retrieves models from the hierarchical storage system, processes the requests and delivers the results back to the result handling module 306 on the client side. This module ensures that inference tasks are executed with minimal latency and maximum accuracy, leveraging the dynamic resource allocation and caching mechanisms of the system.

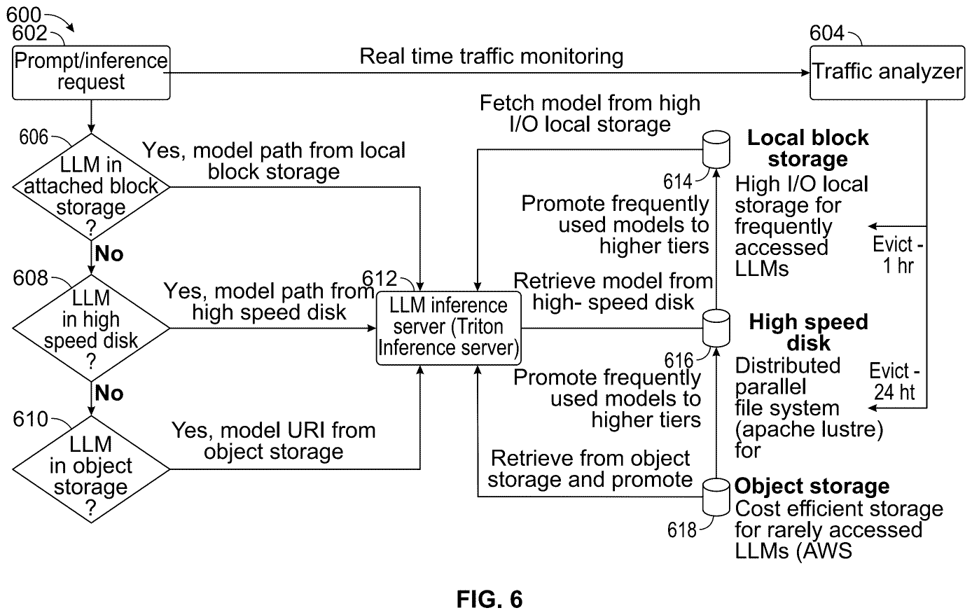

Referring to FIG. 5 is a block diagram 500 depicting a system architecture designed to facilitate efficient and scalable deployment of Large Language Models (LLMs). The system 500 emphasizes minimizing cold-start latency, optimizing GPU utilization, and enabling cost-effective scalability. It achieves these objectives through a tightly integrated combination of modules, each contributing to specific functionalities such as request handling, traffic analysis, hierarchical storage management, preloading, and GPU orchestration. The architecture is designed to handle thousands of LLMs simultaneously, ensuring high performance and resource optimization. The LLM Prompt/Inference Request Handler 502 serves as the primary entry point for user-generated inference requests. This module interprets incoming requests, identifies the specific LLM required, and forwards the requests to subsequent modules for processing. By acting as the initial interface between the user and the system, the request handler ensures that all requests are efficiently logged and prioritized according to predefined service-level agreements (SLAs). This prioritization mechanism enables the system to allocate resources effectively, particularly during periods of high demand. The Traffic Analyzer 504 may be configured to predict and manage incoming demand. The Traffic Analyzer 504 continuously monitors real-time request patterns while analyzing historical traffic data to forecast future spikes in demand. By leveraging advanced predictive algorithms, the Traffic Analyzer 504 provides insights that guide other modules, such as the LLM Preloading Engine 506 and the GPU Orchestrator 518, in proactively preparing for high-traffic scenarios. This predictive capability ensures that high-demand models are preloaded into faster storage tiers, significantly reducing cold-start latency and enhancing overall system responsiveness. The Hierarchical LLM Storage Manager 508 oversees the multi-tiered storage system, which is a cornerstone of the architecture's efficiency. The storage system is divided into three tiers: Hot Storage 512, Warm Storage 514, and Cold Storage 516. Models in the hot storage tier 512 are stored in ultra-fast memory, such as RAM or NVMe storage, enabling near-instantaneous retrieval for inference tasks. The warm storage tier 514 utilizes high-speed SSDs, parallel distributed file systems, or similar mediums, balancing performance and cost for models with moderate access frequency. Cold storage 516, on the other hand, relies on scalable object storage solutions like AWS S3, prioritizing cost efficiency for infrequently accessed models. The Hierarchical LLM Storage Manager 508 dynamically transitions models between these tiers based on usage patterns and traffic forecasts, ensuring optimal storage resource utilization while minimizing latency. The LLM Preloading Engine 506 works in conjunction with the Traffic Analyzer 504 to proactively load models into the hot and warm storage tiers. By analyzing traffic forecasts, the Preloading Engine 506 identifies models likely to experience increased demand and ensures they are readily accessible in higher storage tiers. This proactive approach eliminates delays associated with loading models from cold storage during peak traffic periods, improving the system's ability to deliver real-time responses. The Preloading Engine 506 also carefully manages system resources to avoid overloading during the preloading process, striking a balance between preparedness and resource availability. The GPU Orchestrator 518 dynamically allocates GPU resources to active models based on real-time demand. The GPU Orchestrator 518 ensures efficient utilization of GPUs by enabling resource sharing across multiple active models, thereby reducing idle GPU time and preventing over-provisioning. When an inference request is received, the GPU Orchestrator 518 works in tandem with the Hierarchical LLM Storage Manager to fetch the required LLM model and execute the inference task. This dynamic allocation capability enhances scalability, enabling the system to handle a larger number of LLMs with limited physical GPU resources. The LLM Clean-Up Agent 510 is responsible for maintaining storage efficiency by managing the eviction of unused models from higher-tier caches. It continuously monitors usage patterns across the hot and warm storage tiers, identifying models that are no longer active or frequently accessed. When storage tiers approach capacity, the Clean-Up Agent evicts the least recently used (LRU) models and safely transitions them to lower-tier storage. This ensures that active models always have sufficient resources, preventing bottlenecks and maintaining the system's performance under heavy workloads. The workflow between these components is tightly integrated to maximize efficiency. When a request is received, the LLM Prompt/Inference Request Handler 502 forwards it to the Traffic Analyzer 504, which evaluates current demand and forecasts future usage patterns. If the required model resides in the hot storage tier, it is retrieved immediately, ensuring minimal latency. For models stored in the warm or cold tiers, the system triggers the Preloading Engine 506 to move the model into the hot tier, preparing it for inference. The GPU Orchestrator 518 then assigns GPU resources to execute the inference task, ensuring optimal utilization of available hardware. After the task is completed, the LLM Clean-Up Agent 510 evaluates storage tiers to evict unused models, maintaining optimal resource allocation for active models. In summary, FIG. 5 represents a highly integrated system architecture tailored for large-scale LLM deployments. By combining predictive traffic analysis, hierarchical storage management, dynamic GPU allocation, and proactive preloading, the system ensures high performance, cost efficiency, and scalability. Each module contributes to the overall goal of optimizing resource utilization while delivering seamless real-time responses, making it an ideal solution for modern AI applications.

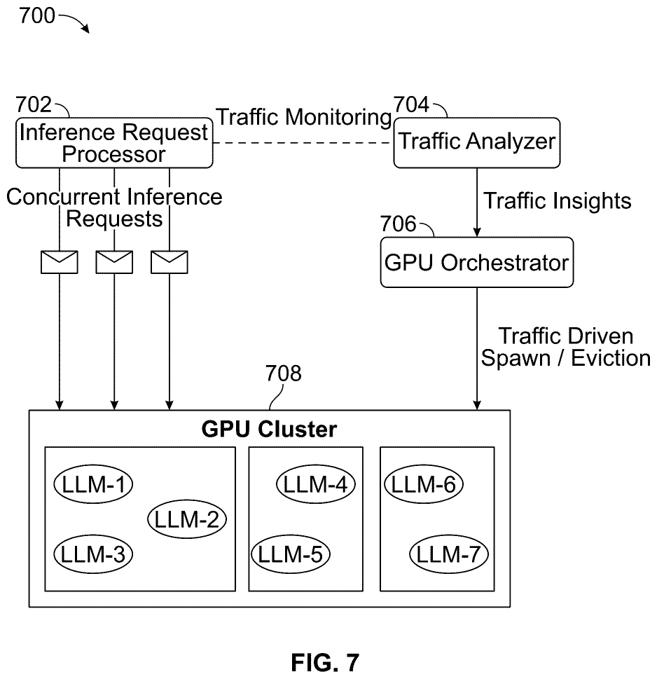

Referring to FIG. 6 is a block diagram 600 depicting a storage flow architecture to facilitate efficient and scalable deployment of Large Language Models (LLMs), in accordance with one or more exemplary embodiments. The storage workflow begins when a user submits an inference request through the Prompt/Inference Request Handler 602. This request includes the model identifier, necessary inference parameters, and metadata such as priority or latency constraints. The Request Handler may be configured to initiate a hierarchical lookup process to locate the requested model across the available storage tiers. This entry point ensures that the user's demand is acknowledged and processed efficiently, acting as the gateway to the entire storage workflow. The system systematically searches for the requested model across the three-tier storage architecture, starting with the highest-performance tier (local block storage) and progressing to lower tiers (high-speed disk and object storage) if necessary.

Tier 1: Local Block Storage, the highest-speed tier, may be configured to store frequently accessed models in high-performance NVMe SSDs directly attached to inference servers. If the requested model is located in this tier, it is immediately fetched and loaded into the inference engine. The low latency of this storage ensures near-instantaneous access. If the model is not present in this tier, the system proceeds to the next tier. Tier 2: High-Speed Disk, the high-speed disk tier, which may rely on a distributed parallel file system such as Apache Lustre, serves as a shared medium-latency storage solution. This tier is designed for models with moderate access frequencies. If the model resides in this tier, it is retrieved and loaded into the inference engine. The system may also preload the model into local block storage to enhance future access speed. If the model is not found in this tier, the system moves to the next tier. Tier 3: Object Storage, the object storage tier is designed for rarely accessed models and uses scalable, cost-efficient storage solutions like AWS S3. While retrieval latency is higher in this tier, the system mitigates this by promoting frequently accessed models to higher tiers. If the requested model resides in this tier, it is retrieved, temporarily loaded into high-speed disk or local block storage, and served to the user. The hierarchical lookup process ensures that frequently accessed models remain in higher tiers for low-latency access, while less frequently accessed models are stored in cost-efficient storage tiers.

The Traffic Analyzer 604 may be configured to monitor real-time traffic patterns and predict future demand. Based on its analysis, frequently accessed models are proactively promoted to higher tiers. For instance, a model experiencing a sudden surge in requests may be promoted from object storage to high-speed disk and subsequently to local block storage. This promotion mechanism dynamically adjusts to ensure high-priority models are readily available in high-performance tiers, significantly reducing cold-start latency for popular models.

Storage Miss Handling: If a requested model is not found in local block storage or high-speed disk, the system identifies this as a storage miss. In such cases, the model is retrieved from object storage and temporarily loaded into high-speed disk for processing. Depending on traffic patterns, the model may also be promoted to local block storage for subsequent use. This ensures that models are always available for inference, regardless of their original storage tier, and that retrieval latency is minimized.

Model Eviction and Demotion: to maintain sufficient capacity in high-performance storage tiers, the system periodically evaluates stored models for eviction. The Eviction Process may be configured to demote models to lower storage tiers based on the following criteria: Inactivity Duration: Models that have not been accessed for a predefined period are marked for demotion. Least Recently Used (LRU): Models with the lowest access frequency are prioritized for eviction. Evicted models are demoted to lower tiers, such as from local block storage to high-speed disk or from high-speed disk to object storage. This process ensures that storage resources remain available for active models, maintaining a balance between performance and cost efficiency. Integration with LLM Inference Serve. Once a model is retrieved from the appropriate storage tier, it is sent to the LLM Inference Server, which may be configured to execute the inference task. The inference server interfaces with the hierarchical storage system to ensure seamless access to the required models. This integration allows the system to handle inference requests efficiently, even during periods of high demand.

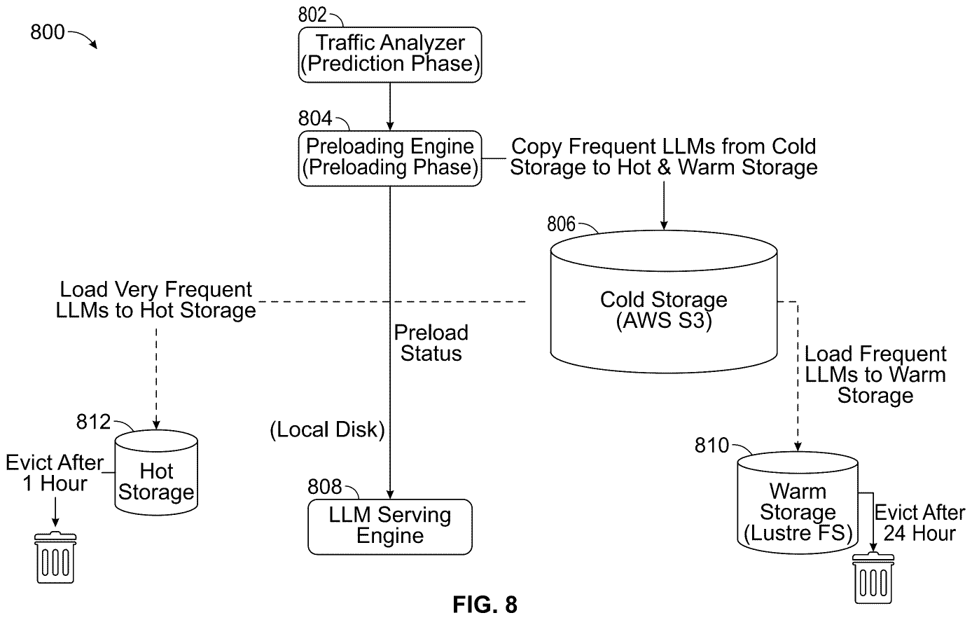

Referring to FIG. 7 is a block diagram 700 depicting a GPU sharing workflow 700 for dynamically managing GPU resources in real-time to support inference servers hosting Large Language Models (LLMs). This system is designed to address the challenges associated with maintaining high-performance LLM inference, such as managing concurrent requests, optimizing GPU usage, and reducing operational costs. Each component is described below. The Inference Request Processor 702 may be configured to handle and process user-generated inference requests. It acts as the primary entry point for the workflow, organizing and forwarding requests to other components. The Inference Request Processor 702 receives requests containing the model identifier, input parameters, and associated metadata, such as urgency or priority as defined by Service Level Agreements (SLAs). It organizes the incoming requests into a queue for systematic processing, ensuring no bottlenecks in handling high volumes of concurrent requests. After queuing, the requests are forwarded to the Traffic Analyzer 704 for real-time traffic analysis.

The Traffic Analyzer 704 may be configured to monitor traffic patterns in real-time while leveraging historical data to predict demand surges. It performs a critical role in ensuring efficient GPU resource management by identifying high-traffic or low-traffic periods for individual models. The Traffic Analyzer 704 uses advanced time series forecasting algorithms to analyze incoming requests and traffic patterns. Based on this analysis, it triggers actions such as activating GPU resources for high-traffic models or identifying models that are no longer receiving requests. These insights are communicated to the GPU Orchestrator 706, enabling dynamic resource allocation and traffic-driven evictions. The Traffic Analyzer 704 ensures that high-demand models receive the necessary resources while minimizing resource wastage for inactive models.

The GPU Orchestrator 706 may be configured to dynamically allocate and manage GPU resources for inference tasks. It serves as the core of the GPU sharing system, ensuring that resources are allocated based on demand and deallocated when no longer needed. The GPU Orchestrator 706 dynamically starts inference servers by preloading required LLMs into the GPU Cluster 708 from high-speed storage tiers, such as NVMe or parallel file systems (e.g., Apache Lustre). It also shuts down inference servers when traffic diminishes, reclaiming GPU resources for other tasks. Furthermore, the GPU Orchestrator supports concurrent inference by sharing GPU resources across multiple tasks, ensuring high performance and cost efficiency. This dynamic management reduces the need for always-on infrastructure, achieving significant operational cost savings. The GPU Cluster 708 may be configured to host inference servers for LLMs, dynamically supporting multiple models and tasks simultaneously. It comprises a set of GPUs capable of handling both high-priority and concurrent inference requests. Each GPU in the cluster can be dynamically assigned to host one or more LLMs based on traffic demands. The GPU Cluster 708 supports parallel processing, enabling efficient resource utilization. By sharing computational resources across multiple inference requests, it eliminates idle GPU time and maximizes throughput. High-priority tasks are executed with minimal latency to meet SLA requirements, while lower-priority tasks are queued or deferred based on resource availability. The system includes a traffic-driven eviction mechanism that may be configured to shut down inference servers hosting inactive models. The Traffic Analyzer 704 continuously monitors the activity of hosted models. If a model does not receive requests for a predefined period (e.g., 300 seconds), the Traffic Analyzer 704 signals the GPU Orchestrator 706 to reclaim the associated resources. Inactive servers are gracefully shut down, and their models are demoted to lower storage tiers, such as high-speed disk or object storage, for future retrieval. This process prevents resource wastage and ensures that GPUs are available for high-demand models.

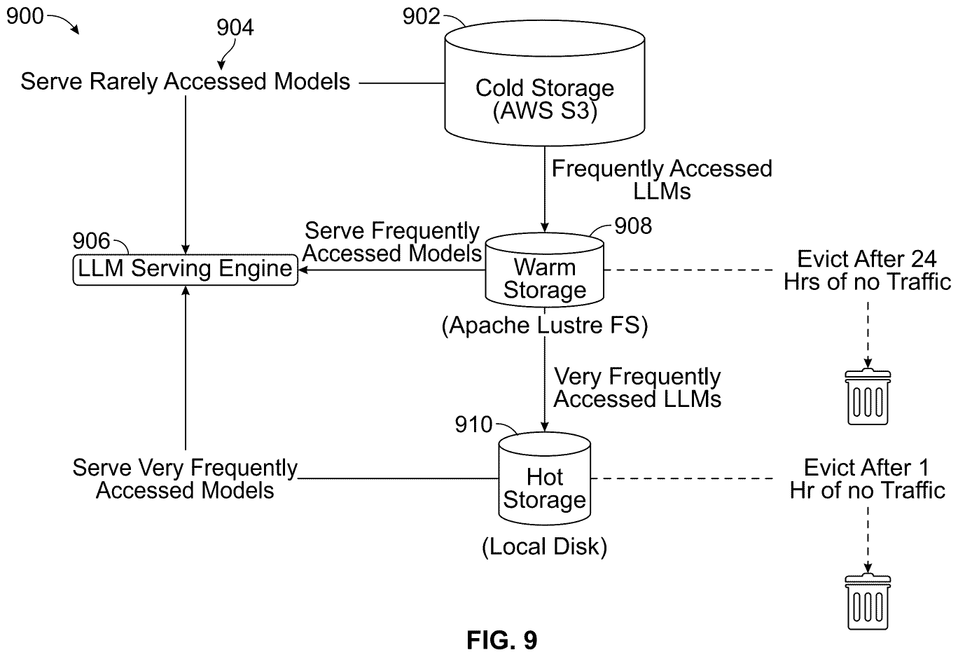

Referring to FIG. 8 is a block diagram 800 depicting Cold-Start Latency Optimization mechanisms, in accordance with one or more exemplary embodiments. The Traffic Analyzer 802 may be configured to monitor real-time traffic patterns and analyze historical data to predict demand for specific LLMs. By identifying high-demand models, the traffic analyzer 802 marks these models for preloading into high-performance storage tiers, such as Hot Storage 812 or Warm Storage 810. The Traffic Analyzer 802 uses advanced predictive algorithms to classify LLMs into priority levels (e.g., high, medium, or low) based on expected traffic volume and request frequency. This classification ensures that frequently accessed models are prioritized for preloading, minimizing delays during user requests. By continuously monitoring factors such as request frequency, user behavior, and time-based patterns, the Traffic Analyzer 802 ensures that the system remains responsive to fluctuating demands. The Preloading Engine 804 may be configured to retrieve high-priority LLMs from lower-performance storage tiers (e.g., Cold Storage 806) and promote them to higher tiers (e.g., Warm Storage 810 or Hot Storage 812) for faster access. This proactive preloading process ensures that critical models are readily available when needed. The Preloading Engine 804 interacts with the hierarchical storage system to dynamically manage model transitions: Hot Storage 812: Frequently accessed models requiring near-instantaneous access are loaded into local high-I/O storage devices, such as NVMe SSDs. Warm Storage 810: Moderately accessed models are stored in high-speed mediums, such as SSDs or distributed parallel file systems (e.g., Apache Lustre). Cold Storage 806: Rarely accessed models are stored in cost-efficient object storage solutions like AWS S3. By preloading high-priority models into appropriate tiers, the system reduces the time required to serve user requests and balances speed and cost. During the execution phase, user requests are processed using preloaded models to ensure minimal latency. The LLM Serving Engine (808) may be configured to route requests to the appropriate storage tier based on the availability of the requested model. Hot Storage 812: Requests for frequently accessed models are served immediately with near-zero latency. Warm Storage 810: Requests for moderately accessed models are served with slightly higher latency. Cold Storage 806: If a model is not found in Hot or Warm Storage, it is retrieved from Cold Storage, preloaded into Hot Storage, and then served. This tiered approach ensures that high-SLA tasks are processed first, maintaining user satisfaction and system performance.

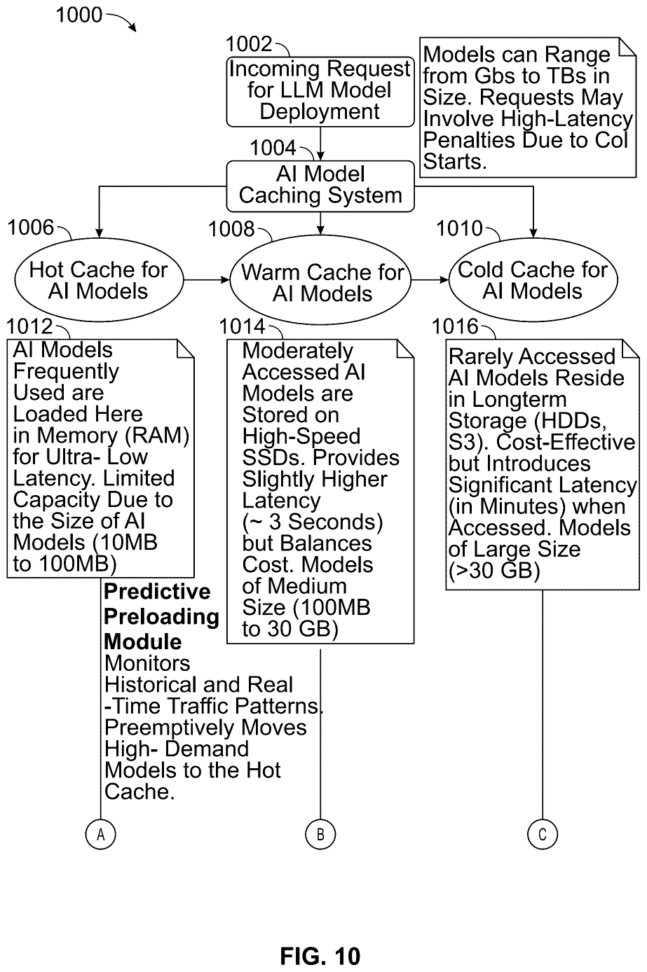

Referring to FIG. 9 is a block diagram 900 depicting a hierarchical storage architecture for efficiently managing the storage and retrieval of Large Language Models (LLMs) across multiple storage tiers, in accordance with one or more exemplary embodiments.

The Cold Storage 902 is configured to store rarely accessed LLMs in cost-efficient, scalable object storage systems, such as AWS S3. It is designed to provide long-term retention of low-demand models while minimizing storage costs. Although retrieval latency is higher for this tier, the system mitigates its impact by promoting frequently accessed models to higher-performance tiers. Models stored in Cold Storage remain accessible during cache misses, ensuring that all LLMs can be retrieved when needed. The Warm Storage 908 serves as an intermediary layer, storing models that are moderately accessed. Utilizing high-speed distributed file systems, such as Apache Lustre, this tier strikes a balance between performance and cost. Models predicted to experience moderate traffic are stored here, offering slightly higher latency compared to Hot Storage but maintaining sufficient speed for many applications. Warm Storage plays a critical role in alleviating the load on Hot Storage while ensuring accessibility for models with fluctuating traffic patterns. When models in Warm Storage become highly active, they are promoted to Hot Storage for immediate availability. The Hot Storage 910 is the highest-performance tier, configured to store very frequently accessed LLMs. This tier relies on high-speed local storage solutions, such as NVMe SSDs, to provide near-instantaneous access for critical inference tasks. Models stored in Hot Storage are served with minimal latency, enabling the system to meet stringent performance requirements for real-time applications. To maintain efficiency, inactive models in Hot Storage are evicted to Warm Storage after one hour of inactivity, ensuring that only active models occupy the highest-speed resources. The LLM Serving Engine 906 orchestrates the retrieval and serving of LLMs from the appropriate storage tier. When a user request is received, the engine first checks Hot Storage for the requested model. If the model is not available in Hot Storage, the engine retrieves it from Warm Storage or Cold Storage, depending on its location. For cache misses, models retrieved from Cold Storage are promoted to higher-performance tiers to reduce latency for future requests. This mechanism ensures seamless service continuity, even when models are initially stored in the lowest tier. The architecture incorporates dynamic mechanisms for preloading and evicting models. The preloading mechanism ensures that high-priority models are proactively moved from Cold Storage to higher-performance tiers before they are needed. This process is guided by traffic prediction algorithms that analyze real-time and historical data to forecast demand. By preloading frequently accessed models into Warm or Hot Storage, the system drastically reduces cold-start latency, ensuring rapid responses to user requests. Conversely, the eviction mechanism optimizes storage utilization by demoting inactive models from Hot and Warm Storage to lower tiers. Models in Hot Storage are evicted to Warm Storage after one hour of inactivity, while models in Warm Storage are demoted to Cold Storage after 24 hours of inactivity. This automated process maintains the efficiency of high-performance storage resources while ensuring cost-effective retention of inactive models. The hierarchical storage architecture presented in FIG. 9 demonstrates an innovative approach to managing LLMs at scale. By leveraging predictive analytics, dynamic tier transitions, and resource-efficient storage technologies, the system achieves a balance between performance, scalability, and cost optimization. This architecture is particularly well-suited for modern AI applications that require rapid, low-latency access to LLMs while accommodating the varied traffic patterns of large-scale deployments.

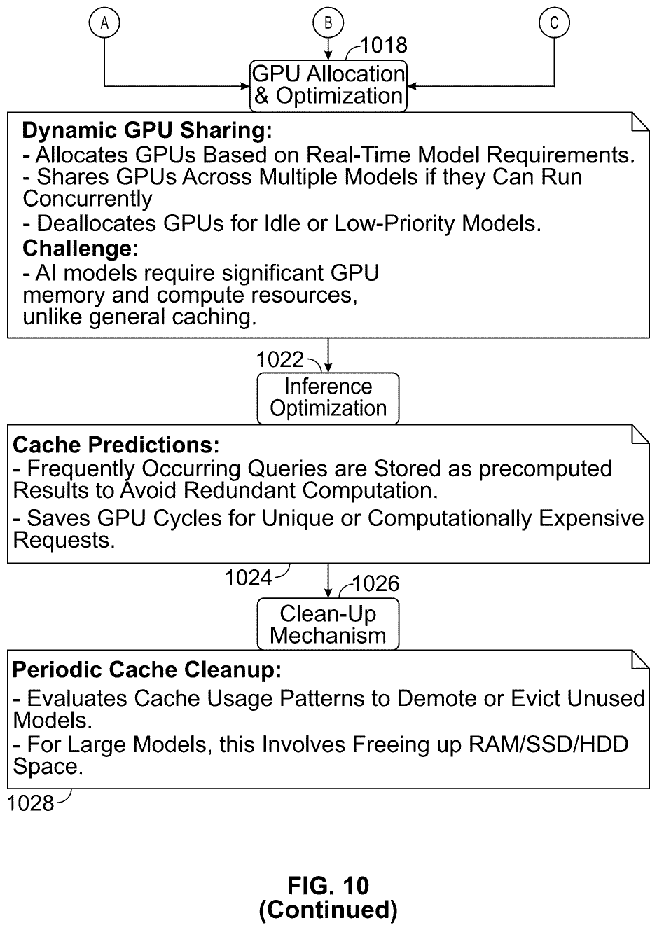

Referring to FIG. 10 is a block diagram 1000 depicting a hierarchical AI model storage system that integrates predictive preloading, GPU allocation, inference optimization, and clean-up mechanisms to efficiently handle the unique challenges posed by serving Large Language Models (LLMs). These models, with their immense sizes ranging from tens to hundreds of gigabytes and even terabytes, require specialized systems to manage cold-start latency, optimize resource utilization, and ensure scalability for modern AI applications. The depicted system begins with an incoming request module, designated as 1002, which processes user or API requests for deploying LLMs. Each request specifies the target model and its associated parameters, initiating a workflow designed to ensure low latency and high efficiency in serving these computationally intensive workloads. The core of the system lies in its hierarchical AI model storage system, represented as 1004, which organizes models into three distinct tiers of storage based on access patterns and demand frequency. The topmost tier, referred to as Hot Storage 1006, is optimized for storing frequently accessed models in high-speed local storage such as NVMe SSDs or Direct Attached Storage (DAS). This tier provides near-instantaneous access, with retrieval latencies of less than one second, making it suitable for the most critical and high-demand models. The next tier, Warm Storage 1008, accommodates moderately accessed models and employs high-speed SSDs or network-attached storage solutions like Apache Lustre. While slightly slower than the hot tier, with retrieval times of approximately two to three seconds, warm storage strikes a balance between speed and cost, making it ideal for models with medium-level demand. The third tier, Cold Storage 1010, is dedicated to infrequently accessed models and leverages cost-efficient long-term storage solutions such as cloud object storage systems like AWS S3 or Google Cloud Storage. This tier prioritizes storage efficiency over retrieval speed, with latency measured in seconds to minutes, depending on the model size and system configuration. To address cold-start latency and optimize model availability, the predictive preloading module, identified as 1018, analyzes both historical and real-time traffic patterns. This module is tasked with forecasting demand for specific models and preemptively moving high-priority models from the cold and warm tiers into the hot tier. By ensuring that frequently requested models are preloaded into high-speed storage, the system significantly reduces delays during traffic spikes, enabling a seamless experience for end-users. Once models are preloaded and ready, the GPU allocation and optimization module, labeled as 1020, dynamically assigns GPU resources based on real-time traffic and model requirements. This module supports the sharing of GPU resources across multiple models running concurrently, effectively reducing idle GPU time and maximizing resource utilization. When traffic diminishes or models become idle, GPUs are deallocated or reassigned to other active tasks, conserving computational resources and energy. The system also incorporates an inference optimization module, represented as 1022, to further enhance response times and reduce redundant computations. This module leverages inference optimization techniques, such as storing precomputed results for frequently occurring queries. By caching these query results, the module minimizes computational overhead and conserves GPU cycles for unique or computationally intensive requests, thereby improving overall system throughput. Finally, the clean-up mechanism, identified as 1026, performs automated storage management by evaluating usage patterns and demoting or evicting unused models from higher-tier storage. This process frees up space in hot and warm storage tiers, ensuring that the hierarchical storage system operates efficiently without manual intervention. Through its combination of hierarchical storage, predictive preloading, dynamic GPU allocation, inference optimization, and automated clean-up, the system depicted in FIG. 10 delivers a comprehensive solution for managing large-scale AI workloads. By addressing key challenges such as cold-start latency, resource wastage, and computational inefficiencies, this architecture provides a scalable, cost-effective, and high-performance framework for deploying LLMs in modern AI applications.

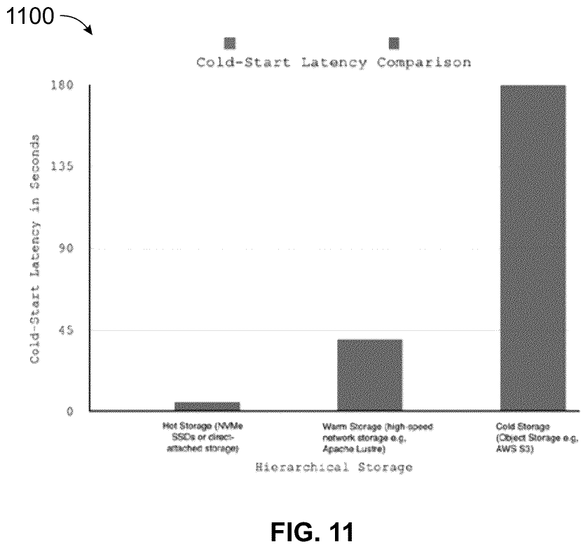

Referring to FIG. 11 is an example diagram 1100 depicting a Cold-Start Latency Comparison across the hierarchical storage tiers—Hot Storage, Warm Storage, and Cold Storage, in accordance with one or more exemplary embodiments. The storage tiers—Hot Storage, Warm Storage, and Cold Storage—are integral components of the proposed system, designed to balance speed, capacity, and cost for efficient management of Large Language Models (LLMs). The figure demonstrates how the hierarchical storage framework mitigates latency issues associated with model retrieval, particularly for large-scale LLMs. The Hot Storage tier, as depicted in the figure, achieves the lowest cold-start latency, typically under 5 seconds. This tier may be configured to utilize high-speed storage devices such as NVMe SSDs or direct-attached storage, optimized for low-latency operations. Models frequently accessed by users are dynamically loaded into this tier based on traffic patterns, ensuring immediate availability for real-time inference requests. The fast retrieval times make Hot Storage the ideal solution for critical, high-priority workloads. The Warm Storage tier offers a balance between performance and cost, with a cold-start latency of approximately 40 seconds. This tier may be configured to use SSDs or high-speed distributed storage systems such as Apache Lustre. Moderately accessed models are placed in Warm Storage, serving as an intermediary layer between the high-speed Hot Storage and the cost-efficient Cold Storage. When demand for specific models increases, the system promotes them from Warm Storage to Hot Storage to meet real-time requirements. In contrast, the Cold Storage tier is designed for long-term, cost-effective storage of rarely accessed models. This tier may be configured to leverage object storage systems like AWS S3, Google Cloud Storage, or similar technologies. As illustrated in the figure, Cold Storage incurs the highest retrieval latency, often exceeding 180 seconds. While this latency is acceptable for archival purposes or infrequent access, the system ensures that models stored in Cold Storage are promoted to higher tiers when demand increases, effectively reducing future cold-start delays. The hierarchical caching system, is represented in FIG. 11, demonstrates the effectiveness of tiered storage in addressing latency challenges for LLM deployments. By leveraging predictive preloading and traffic analysis, the system ensures that high-priority models are preloaded into Hot Storage, achieving industry-leading cold-start latency metrics. This approach transforms LLM management by providing scalable, cost-efficient, and low-latency solutions for cloud-based AI marketplaces. In conclusion, FIG. 11 underscores the critical role of hierarchical storage in balancing performance, cost, and scalability for LLM deployments. It highlights how the proposed system dynamically transitions models between storage tiers to meet varying traffic demands, ensuring optimal resource utilization and seamless user experiences.

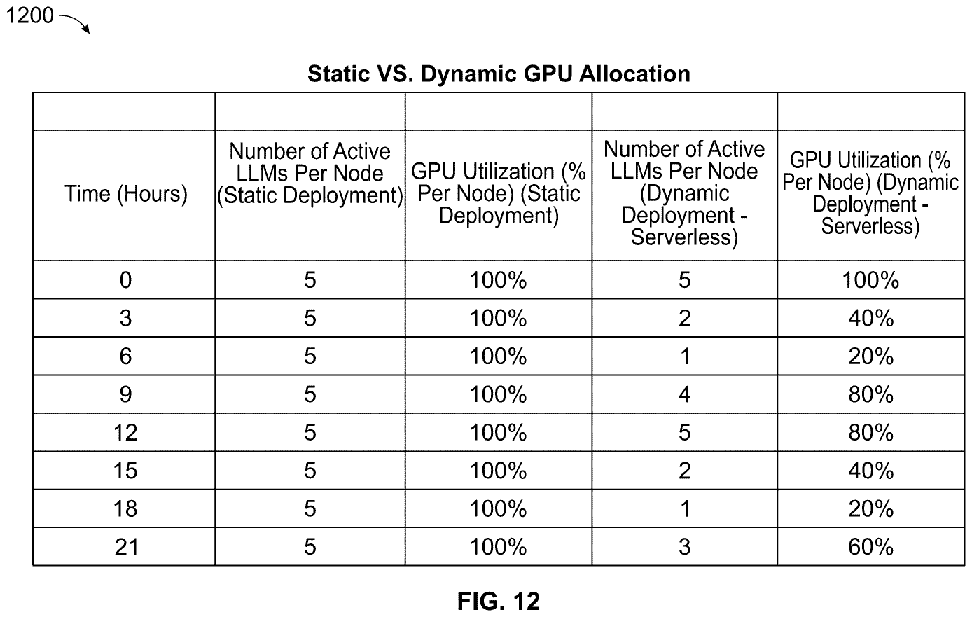

Referring to FIG. 12 is an example diagram 1200 depicting a tabular comparison of the performance and resource utilization between static and dynamic GPU allocation approaches for deploying Large Language Models (LLMs). The figure highlights key differences in GPU utilization and the number of active LLMs per node across various time intervals, showcasing the advantages of dynamic GPU allocation in optimizing resource usage and minimizing operational costs. The Static GPU Allocation approach, as shown in the left-hand columns, may be configured to assign a fixed number of GPUs to LLMs, maintaining all assigned models in GPU memory regardless of real-time traffic demands. For each time interval, the number of active LLMs per node remains fixed at 5, with GPU utilization consistently at 100%. This approach ensures maximum GPU memory allocation but leads to significant inefficiencies, as resources remain fully occupied even during periods of low or no traffic. The lack of adaptability results in resource wastage and increased operational costs during off-peak hours. Conversely, the Dynamic GPU Allocation (Serverless Deployment) approach, as depicted in the right-hand columns, may be configured to dynamically adjust GPU usage based on real-time traffic demand. For example: At 3 hours, the number of active LLMs per node decreases to 2, and GPU utilization drops to 40%. At 6 hours, with reduced traffic, only 1 LLM remains active per node, and GPU utilization decreases further to 20%. As traffic increases at 9 hours, the system dynamically scales up to accommodate 4 active LLMs per node, increasing GPU utilization to 80%. This serverless deployment model efficiently matches GPU allocation to traffic demands, conserving resources during low-demand periods and scaling up during traffic spikes. By deallocating GPUs for idle or low-priority models, the system minimizes idle GPU time, reduces energy consumption, and achieves significant cost savings compared to the static allocation approach. The table also illustrates how dynamic GPU allocation enhances scalability. The system may be configured to support additional LLMs during peak traffic without requiring dedicated hardware for each model. This adaptability ensures optimal performance and cost efficiency, making the serverless deployment model suitable for large-scale AI marketplaces and real-time inference applications. In summary, FIG. 12 underscores the limitations of static GPU allocation, including resource wastage and lack of scalability, and highlights the advantages of dynamic GPU allocation in terms of cost savings, resource optimization, and adaptability to fluctuating traffic patterns. This comparison provides quantitative evidence of the effectiveness of dynamic GPU allocation in modern AI workloads, particularly for large-scale LLM deployments.

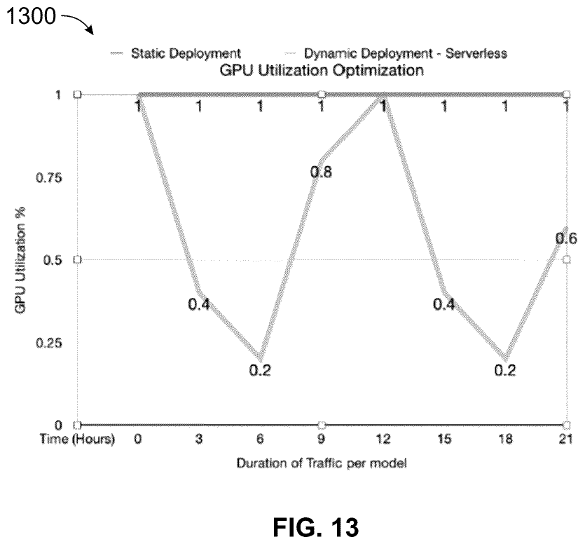

Referring to FIG. 13 is an example diagram 1300 depicting a graphical representation of GPU utilization under static and dynamic deployment methods for managing LLM inference workloads over a 21-hour period, in accordance with one or more exemplary embodiments. The figure highlights the inefficiencies of static allocation, which maintains constant GPU utilization irrespective of demand, and the advantages of dynamic allocation, which adjusts resources in response to real-time traffic patterns. The static deployment approach may be configured to allocate GPUs permanently to LLMs, maintaining a utilization rate of 100% at all times. While this ensures that all deployed models are readily available, it results in significant resource wastage during periods of low traffic. For example, even when only one or two LLMs are active, the GPUs remain fully occupied, leading to inefficiencies in energy consumption and operational costs. During these periods, all five LLMs per node are active, leading to full GPU utilization (100%). The dynamic allocation matches the static approach during high demand, ensuring timely responses to inference requests. In periods of reduced traffic, only one or two LLMs require GPU resources. Dynamic allocation adjusts GPU utilization to 20-40%, evicting idle models and conserving resources. This ensures that GPU nodes are not over-provisioned during periods of low activity. Traffic patterns reflect moderate demand, with three or four active LLMs per node. Dynamic allocation scales GPU utilization to 60-80%, balancing resource availability with actual demand. This adaptive approach ensures that GPU resources are efficiently utilized, minimizing idle time and energy consumption. For the described system, equipped with NVIDIA H200 GPUs capable of hosting up to five LLMs per node, the dynamic deployment achieves an average GPU utilization of approximately 55% over the 21-hour period. This represents a significant improvement in resource efficiency compared to the static deployment, which consistently operates at 100% utilization. The benefits of dynamic GPU allocation extend beyond resource optimization. By reallocating GPUs during low-demand periods, the system supports additional LLMs dynamically, enhancing scalability by up to 50% in a 10-node cluster. Furthermore, this method reduces operational costs by 40-50% compared to static allocation, including savings in power consumption and cooling, thereby contributing to environmental sustainability. To mitigate cold-start latency for evicted models, the system may be configured to reload these models into hot or warm storage tiers for quick retrieval. This ensures that cold-start delays remain minimal, typically under 5 seconds, even during rapid traffic fluctuations. In conclusion, FIG. 13 demonstrates the superiority of dynamic GPU allocation over static allocation in optimizing resource utilization, reducing costs, and supporting scalability for large-scale LLM deployments. This adaptive approach addresses the inefficiencies of traditional static systems, providing a robust solution for modern AI inference workloads.

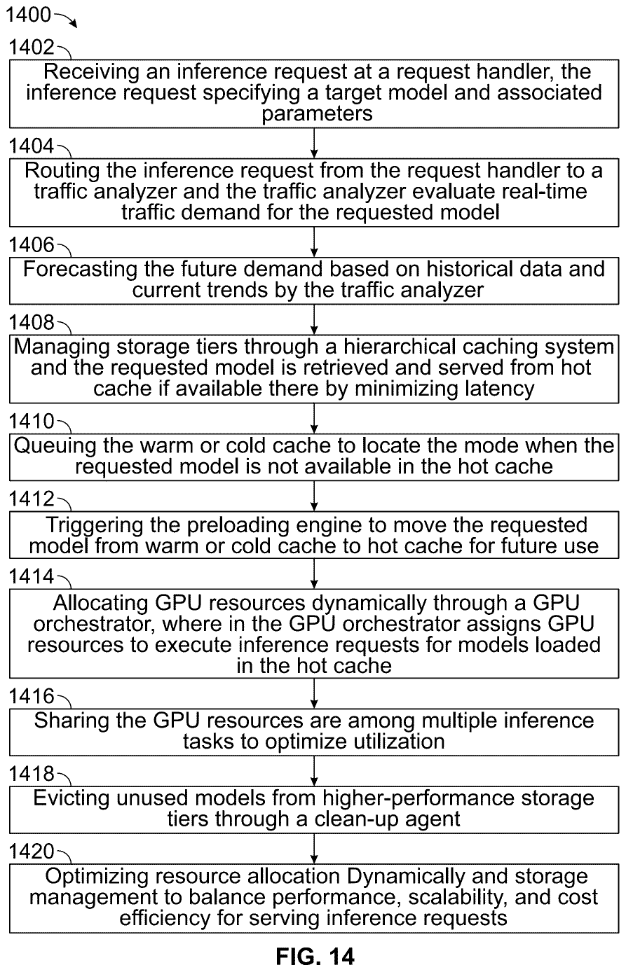

Referring to FIG. 14 is a flow diagram depicting a method for managing inference requests and resource allocation for Large Language Models (LLMs) using a hierarchical caching system, in accordance with one or more exemplary embodiments. The exemplary method 1400 commences at step 1402, receiving an inference request at a request handler, the inference request specifying a target model and associated parameters. Thereafter at step 1404, routing the inference request from the request handler to a traffic analyzer and the traffic analyzer evaluate real-time traffic demand for the requested model. Thereafter at step 1406, forecasting the future demand based on historical data and current trends by the traffic analyzer. Thereafter at step 1408, managing storage tiers through a hierarchical caching system and the requested model is retrieved and served from hot cache if available thereby minimizing latency Thereafter at step 1410, queuing the warm or cold cache to locate the mode when the requested model is not available in the hot cache. Thereafter at step 1412, triggering the preloading engine to move the requested model from warm or cold cache to hot cache for future use. Thereafter at step 1414, allocating GPU resources dynamically through a GPU orchestrator, wherein the GPU orchestrator assigns GPU resources to execute inference requests for models loaded in the hot cache. Thereafter at step 1416, sharing the GPU resources are among multiple inference tasks to optimize utilization. Thereafter at step 1418, evicting unused models from higher-performance storage tiers through a clean-up agent. Thereafter at step 1420, optimizing resource allocation Dynamically and storage management to balance performance, scalability, and cost efficiency for serving inference requests.

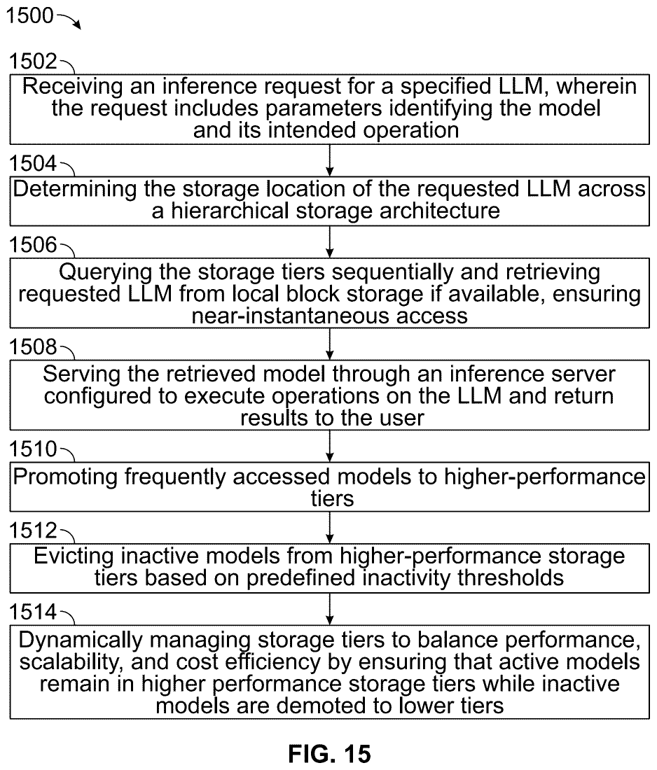

Referring to FIG. 15 is a flow diagram 1500 depicting a method for managing and serving Large Language Models (LLMs) using a hierarchical storage system, in accordance with one or more exemplary embodiments. The exemplary method 1500 commences at step 1502, receiving an inference request for a specified LLM, wherein the request includes parameters identifying the model and its intended operation. Thereafter at step 1504, determining the storage location of the requested LLM across a hierarchical storage architecture. Thereafter at step 1506, querying the storage tiers sequentially and retrieving requested LLM from local block storage if available, ensuring near-instantaneous access. Thereafter at step 1508, serving the retrieved model through an inference server configured to execute operations on the LLM and return results to the user. Thereafter at step 1510, Promoting frequently accessed models to higher-performance tiers. Thereafter at step 1512, evicting inactive models from higher-performance storage tiers based on predefined inactivity thresholds. Thereafter at step 1514, dynamically managing storage tiers to balance performance, scalability, and cost efficiency by ensuring that active models remain in higher-performance storage tiers while inactive models are demoted to lower tiers.

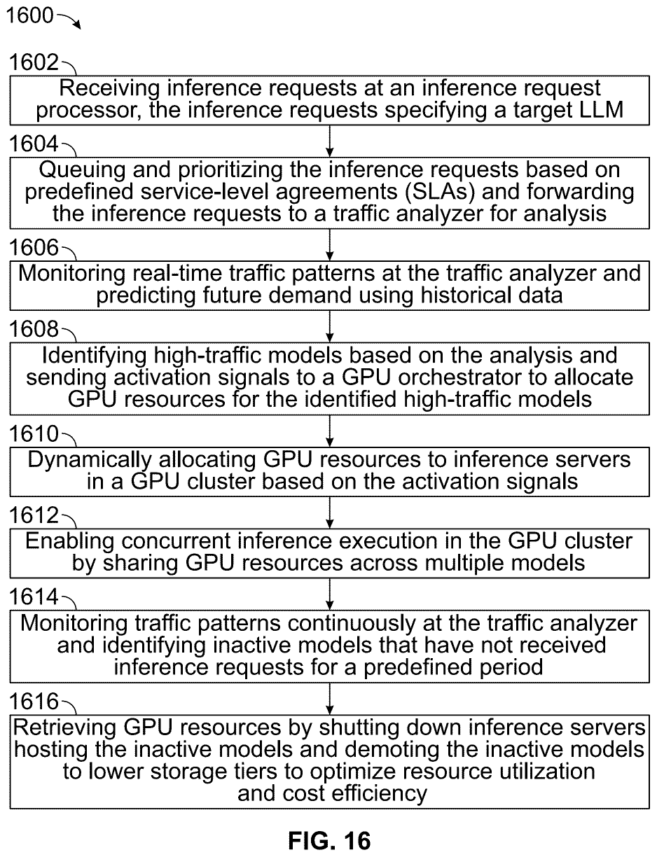

Referring to FIG. 16 is a flow diagram 1600 depicting a method for dynamically managing GPU resources for inference servers hosting large language models (LLMs), in accordance with one or more exemplary embodiments. The exemplary method 1600 commences at step 1602, receiving inference requests at an inference request processor, the inference requests specifying a target LLM, input parameters, and associated metadata. Thereafter at step 1604, queuing and prioritizing the inference requests based on predefined service-level agreements (SLAs) and forwarding the inference requests to a traffic analyzer for analysis. Thereafter at step 1606, monitoring real-time traffic patterns at the traffic analyzer and predicting future demand using historical data. Thereafter at step 1608, identifying high-traffic models based on the analysis and sending activation signals to a GPU orchestrator to allocate GPU resources for the identified high-traffic models. Thereafter at step 1610, dynamically allocating GPU resources to inference servers in a GPU cluster based on the activation signals, wherein the GPU orchestrator preloads the required LLMs from high-speed storage into the GPU cluster. Thereafter at step 1612, enabling concurrent inference execution in the GPU cluster by sharing GPU resources across multiple models, wherein high-priority inference requests are processed first to ensure SLA compliance, and lower-priority requests are queued or executed based on resource availability. Thereafter at step 1614, monitoring traffic patterns continuously at the traffic analyzer and identifying inactive models that have not received inference requests for a predefined period. Thereafter at step 1616, retrieving GPU resources by shutting down inference servers hosting the inactive models and demoting the inactive models to lower storage tiers to optimize resource utilization and cost efficiency.

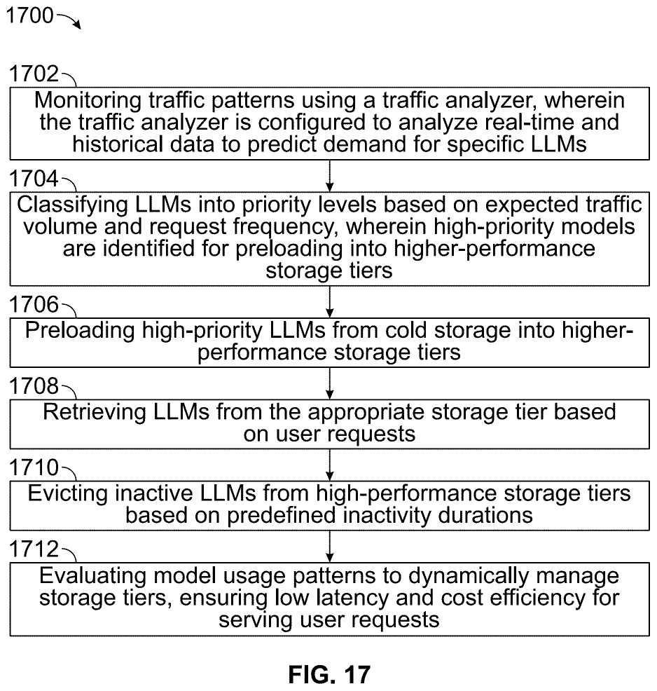

Referring to FIG. 17 is a flow diagram 1700 depicting a method for optimizing latency in large-scale deployments of Large Language Models (LLMs), in accordance with one or more exemplary embodiments. The exemplary method 1700 commences at step 1702, monitoring traffic patterns using a traffic analyzer, wherein the traffic analyzer is configured to analyze real-time and historical data to predict demand for specific LLMs. Thereafter at step 1704, classifying LLMs into priority levels based on expected traffic volume and request frequency, wherein high-priority models are identified for preloading into higher-performance storage tiers. Thereafter at step 1706, preloading high-priority LLMs from cold storage into higher-performance storage tiers. Thereafter at step 1708, retrieving LLMs from the appropriate storage tier based on user requests. Thereafter at step 1710, evicting inactive LLMs from high-performance storage tiers based on predefined inactivity durations. Thereafter at step 1712, evaluating model usage patterns to dynamically manage storage tiers, ensuring low latency and cost efficiency for serving user requests.

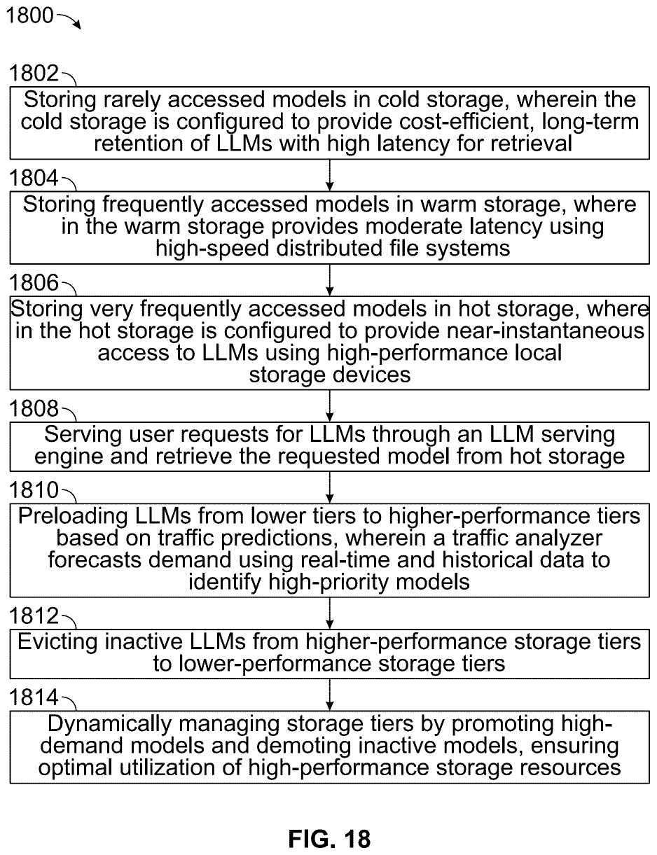

Referring to FIG. 18 is a flow diagram 1800 depicting a method for managing the storage and retrieval of Large Language Models (LLMs) across a hierarchical storage architecture), in accordance with one or more exemplary embodiments. The exemplary method 1800 commences at step 1802, storing rarely accessed models in cold storage, wherein the cold storage is configured to provide cost-efficient, long-term retention of LLMs with high latency for retrieval. Thereafter at step 1804, storing frequently accessed models in warm storage, wherein the warm storage provides moderate latency using high-speed distributed file systems, serving as an intermediary tier between cold storage and hot storage. Thereafter at step 1806, storing very frequently accessed models in hot storage, wherein the hot storage is configured to provide near-instantaneous access to LLMs using high-performance local storage devices. Thereafter at step 1808, serving user requests for LLMs through an LLM serving engine and retrieve the requested model from hot storage. Thereafter at step 1810, preloading LLMs from lower tiers to higher-performance tiers based on traffic predictions, wherein a traffic analyzer forecasts demand using real-time and historical data to identify high-priority models. Thereafter at step 1812, evicting inactive LLMs from higher-performance storage tiers to lower-performance storage tiers. Thereafter at step 1814, dynamically managing storage tiers by promoting high-demand models and demoting inactive models, ensuring optimal utilization of high-performance storage resources while maintaining accessibility for all LLMs.

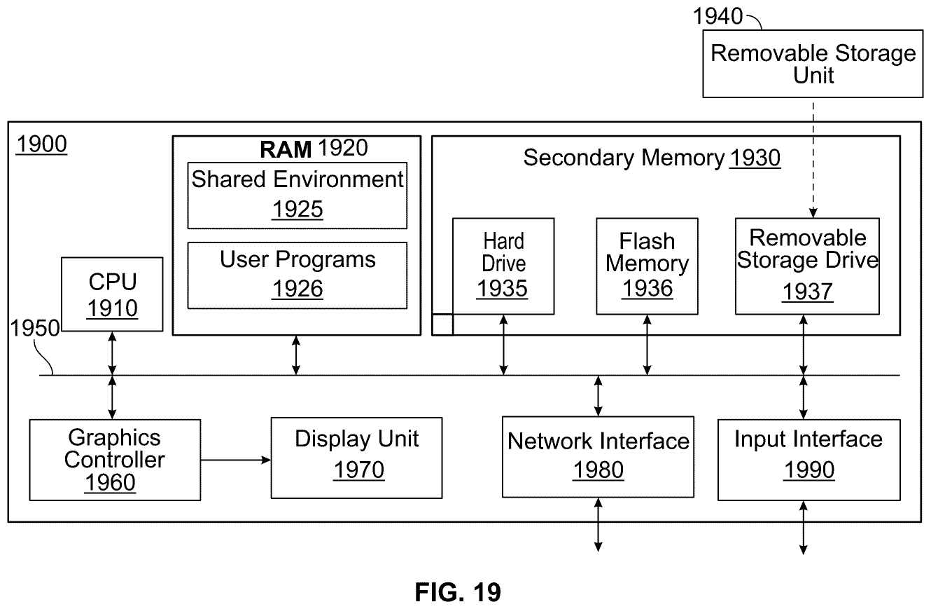

Referring to FIG. 19 is a block diagram 1900 illustrating the details of a digital processing system 1900 in which various aspects of the present disclosure are operative by execution of appropriate software instructions. The Digital processing system 1900 may correspond to the computing devices (or any other system in which the various features disclosed above can be implemented).

Digital processing system 1900 may contain one or more processors such as a central processing unit (CPU) 1910, random access memory (RAM) 1920, secondary memory 1930, graphics controller 1960, display unit, network interface 880, and input interface 1990. All the components except display unit may communicate with each other over communication path 1950, which may contain several buses as is well known in the relevant arts. The components of FIG. 19 are described below in further detail.

CPU 1910 may execute instructions stored in RAM 1920 to provide several features of the present disclosure. CPU 1910 may contain multiple processing units, with each processing unit potentially being designed for a specific task. Alternatively, CPU 1910 may contain only a single general-purpose processing unit.

RAM 1920 may receive instructions from secondary memory 1930 using communication path 1950. RAM 1920 is shown currently containing software instructions, such as those used in threads and stacks, constituting shared environment 1925 and/or user programs 1926. Shared environment 1925 includes operating systems, device drivers, virtual machines, etc., which provide a (common) run time environment for execution of user programs 1926.

Graphics controller 1960 generates display signals (e.g., in RGB format) to display unit 19190 based on data/instructions received from CPU 1910. Display unit contains a display screen to display the images defined by the display signals. Input interface 1990 may correspond to a keyboard and a pointing device (e.g., touch-pad, mouse) and may be used to provide inputs. Network interface 1980 provides connectivity to a network (e.g., using Internet Protocol), and may be used to communicate with other systems connected to the network.

Secondary memory 1930 may contain hard drive 1935, flash memory 836, and removable storage drive. Secondary memory 1930 may store the data software instructions (e.g., for performing the actions noted above with respect to the Figures), which enable digital processing system 1900 to provide several features in accordance with the present disclosure.

Some or all of the data and instructions may be provided on removable storage unit 1940, and the data and instructions may be read and provided by removable storage drive to CPU 1910. Floppy drive, magnetic tape drive, CD-ROM drive, DVD Drive, Flash memory, removable memory chip (PCMCIA Card, EEPROM) are examples of such removable storage drive.

Removable storage unit 1940 may be implemented using medium and storage format compatible with removable storage drive such that removable storage drive can read the data and instructions. Thus, removable storage unit 1940 includes a computer readable (storage) medium having stored therein computer software and/or data. However, the computer (or machine, in general) readable medium can be in other forms (e.g., non-removable, random access, etc.)

In this document, the term “computer program product” is used to generally refer to removable storage unit 1940 or hard disk installed in hard drive 1935. These computer program products are means for providing software to digital processing system 1900. CPU 1910 may retrieve the software instructions, and execute the instructions to provide various features of the present disclosure described above.

In accordance with one or more exemplary embodiments of the present disclosure, the Hot Storage tier is implemented using NVMe SSDs and equivalent high-speed direct-attached storage, and is configured to provide retrieval latency under 5 seconds for frequently accessed models.

In accordance with one or more exemplary embodiments of the present disclosure, the Warm Storage tier is implemented using SSD-based network-attached storage, and is configured to handle moderately accessed models with a retrieval latency of approximately 40 seconds.

In accordance with one or more exemplary embodiments of the present disclosure, the Cold Storage tier is implemented using object storage systems such as AWS S3 and Google Cloud Storage, and is configured for cost-efficient storage of infrequently accessed models with retrieval latency exceeding 180 seconds.

In accordance with one or more exemplary embodiments of the present disclosure, the Traffic Analyzer uses time series forecasting algorithms to predict traffic spikes based on historical data and real-time usage patterns, and configured to identify high-demand models requiring immediate promotion to higher storage tiers.

In accordance with one or more exemplary embodiments of the present disclosure, the GPU Orchestrator dynamically assigns GPU resources to inference tasks based on predefined Service Level Agreement (SLA) priorities and optimizes GPU utilization by sharing resources across multiple models.

In accordance with one or more exemplary embodiments of the present disclosure, the eviction mechanism within the hierarchical storages and resource allocation module is configured to demote models from Hot Storage after 1 hour of inactivity; and demote models from Warm Storage after 24 hours of inactivity.

In accordance with one or more exemplary embodiments of the present disclosure, the hierarchical storage and resource allocation module comprising a predictive preloading module configured to reduce cold-start latency for high-priority models to under 3 seconds by preloading them into Hot and Warm Storage tiers based on traffic forecasts.

In accordance with one or more exemplary embodiments of the present disclosure, the hierarchical storage and resource allocation module comprising a GPU orchestrator module configured to optimize the GPU utilization by dynamically allocating and sharing GPUs across multiple inference tasks simultaneously.

In accordance with one or more exemplary embodiments of the present disclosure, the Clean-Up Agent configured to automate the removal of unused models from storage tiers to free up space for incoming models.

In accordance with one or more exemplary embodiments of the present disclosure, the hierarchical storage system supports models ranging in size from 20 GB to 100 GB, dynamically managing their placement across Hot, Warm, and Cold Storage tiers to balance performance and cost.

In accordance with one or more exemplary embodiments of the present disclosure, the traffic analyzer is configured to trigger the spinning up and shutting down of inference servers based on traffic patterns exceeding or falling below predefined thresholds.

In accordance with one or more exemplary embodiments of the present disclosure, the hierarchical storage tiers support concurrent retrieval and promotion of models during traffic surges, ensuring real-time availability of high-demand models through dynamic tier transitions.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Although the present disclosure has been described in terms of certain preferred embodiments and illustrations thereof, other embodiments and modifications to preferred embodiments may be possible that are within the principles of the invention. The above descriptions and figures are therefore to be regarded as illustrative and not restrictive.

Thus the scope of the present disclosure is defined by the appended claims and includes both combinations and sub-combinations of the various features described here in above as well as variations and modifications thereof, which would occur to persons skilled in the art upon reading the foregoing description.

What is claimed is:

1. A system for large-scale low-latency language-model deployments using dynamic hierarchical storage and GPU optimization, comprising:
a computing device comprising a processor for executing instructions from an inference request module located within the computing device, wherein the inference request module configured to receive inference requests for one or more Large Language Models (LLMs), wherein each inference request includes input parameters and a target model identifier, the inference request module transmit the inference requests to a cloud server over a network based on traffic conditions and predefined service-level agreements (SLAs);
the cloud server comprising a hierarchical storage and resource allocation module configured to manage the placement and retrieval of one or more Large Language Models (LLMs) across a hierarchical storage system comprising a hot storage configured to store frequently accessed models on high-speed, low-latency local storage devices such as NVMe SSDs, a warm storage configured to store moderately accessed models on high-speed network-attached storage, and a cold storage configured to store infrequently accessed models on cost-efficient object storage systems such as AWS S3 or Google Cloud Storage;
the hierarchical storage and resource allocation module configured to promote models dynamically from lower-tier storage (Cold or Warm Storage) to higher-tier storage (Warm or Hot Storage) based on real-time traffic patterns and predicted demand and allocate computational resources, including GPUs, for inference tasks associated with the LLMs, wherein resource allocation is dynamically adjusted to meet active workload demands;
a traffic analyzer operatively coupled to the inference request module and the hierarchical storage and resource allocation module, wherein the traffic analyzer configured to monitor and analyze real-time traffic patterns and historical usage data to predict demand for specific LLMs, whereby the traffic analyzer configured to trigger the preloading of high-demand models into Hot Storage or Warm Storage tiers to minimize cold-start latency;
a GPU orchestrator operatively coupled to the hierarchical storage and resource allocation module, whereby the GPU orchestrator configured to assign GPU resources dynamically to active inference tasks based on model priorities and real-time demand and deallocate GPU resources from idle and low-priority tasks to reduce idle GPU time and optimize resource utilization, wherein the hierarchical storage and resource allocation module configured to demote models from higher-tier storage to lower-tier storage based on predefined inactivity thresholds and ensure optimal utilization of storage tiers by freeing up high-speed storage for active and high-priority models; and
the hierarchical storage and resource allocation module comprises a clean-up agent configured to periodically remove unused models from storage tiers to free up space for incoming models, ensuring sustained operational efficiency, thereby minimizing cold-start latency for LLMs to under 5 seconds through predictive preloading and hierarchical storage management and optimizing GPU utilization by dynamically reallocating resources based on real-time traffic patterns.

2. The system of claim 1, wherein the Hot Storage tier is implemented using NVMe SSDs and equivalent high-speed direct-attached storage, and is configured to provide retrieval latency under 5 seconds for frequently accessed models.

3. The system of claim 1, wherein the Warm Storage tier is implemented using SSD-based network-attached storage, and is configured to handle moderately accessed models with a retrieval latency of approximately 40 seconds.

4. The system of claim 1, wherein the Cold Storage tier is implemented using object storage systems such as AWS S3 and Google Cloud Storage, and is configured for cost-efficient storage of infrequently accessed models with retrieval latency exceeding 180 seconds.

5. The system of claim 1, wherein the traffic analyzer uses time series forecasting algorithms to predict traffic spikes based on historical data and real-time usage patterns, and configured to identify high-demand models requiring immediate promotion to higher storage tiers.

6. The system of claim 1, wherein the GPU orchestrator dynamically assigns GPU resources to inference tasks based on predefined Service Level Agreement (SLA) priorities and optimizes GPU utilization by sharing resources across multiple models.

7. The system of claim 1, wherein the eviction mechanism within the hierarchical storages and resource allocation module is configured to demote models from Hot Storage after 1 hour of inactivity; and demote models from Warm Storage after 24 hours of inactivity.

8. The system of claim 1, wherein the hierarchical storage and resource allocation module comprising a predictive preloading module configured to reduce cold-start latency for high-priority models to under 3 seconds by preloading them into Hot and Warm Storage tiers based on traffic forecasts.

9. The system of claim 1, wherein the hierarchical storage and resource allocation module comprising a GPU orchestrator module configured to optimize the GPU utilization by dynamically allocating and sharing GPUs across multiple inference tasks simultaneously.

10. The system of claim 1, wherein the Clean-Up Agent is configured to automate the removal of unused models from storage tiers to free up space for incoming models.

11. The system of claim 1, wherein the hierarchical storage system supports models ranging in size from 20 GB to 100 GB, dynamically managing their placement across Hot, Warm, and Cold Storage tiers to balance performance and cost.

12. The system of claim 1, wherein the traffic analyzer is configured to trigger the spinning up and shutting down of inference servers based on traffic patterns exceeding or falling below predefined thresholds.

13. The system of claim 1, wherein the hierarchical storage tiers support concurrent retrieval and promotion of models during traffic surges, ensuring real-time availability of high-demand models through dynamic tier transitions.

14. A method for large-scale low-latency language-model deployments using dynamic hierarchical storage and GPU optimization, comprising:
receiving inference requests for one or more Large Language Models (LLMs) using an inference request module of a computing device (GPU), wherein each inference request includes input parameters and a target model identifier;
transmitting the inference requests from the inference request module to a cloud server over a network based on traffic conditions and predefined service-level agreements (SLAs);
managing the placement and retrieval of LLMs across a hierarchical storage system at the cloud server;
storing frequently accessed models in a hot storage tier using high-speed, low-latency local storage devices such as NVMe SSDs;
storing moderately accessed models in a warm storage tier using high-speed network-attached storage;
storing infrequently accessed models in a cold storage tier using cost-efficient object storage systems such as AWS S3 or Google Cloud Storage;
promoting models dynamically from lower-tier storage (Cold or Warm Storage) to higher-tier storage (Warm or Hot Storage) based on real-time traffic patterns and predicted demand;
allocating computational resources, including GPUs, for inference tasks associated with the LLMs, wherein the resource allocation is dynamically adjusted to meet active workload demands;
monitoring and analyzing real-time traffic patterns and historical usage data using a traffic analyzer to predict demand for specific LLMs;
triggering the preloading of high-demand models into Hot Storage or Warm Storage tiers based on the predictions to minimize cold-start latency;
assigning GPU resources dynamically to active inference tasks based on model priorities and real-time demand, and deallocating GPU resources from idle or low-priority tasks to reduce idle GPU time and optimize resource utilization;
demoting models from higher-tier storage to lower-tier storage based on predefined inactivity thresholds, ensuring optimal utilization of high-speed storage by freeing up space for active or high-priority models; and
removing unused models periodically from storage tiers using a clean-up agent to free up space for new models, ensuring sustained operational efficiency.

15. A computer program product comprising a non-transitory computer-readable medium having a computer-readable program code embodied therein to be executed by one or more processors, said program code including instructions to:
receive inference requests for one or more Large Language Models (LLMs) using an inference request module of a computing device (GPU), wherein each inference request includes input parameters and a target model identifier;
transmit the inference requests from the inference request module to a cloud server over a network based on traffic conditions and predefined service-level agreements (SLAs);
manage the placement and retrieval of LLMs across a hierarchical storage system at the cloud server;
store frequently accessed models in a hot storage tier using high-speed, low-latency local storage devices such as NVMe SSDs;
store moderately accessed models in a warm storage tier using high-speed network-attached storage;
store infrequently accessed models in a cold storage tier using cost-efficient object storage systems such as AWS S3 or Google Cloud Storage;
promote models dynamically from lower-tier storage (Cold or Warm Storage) to higher-tier storage (Warm or Hot Storage) based on real-time traffic patterns and predicted demand;
allocate computational resources, including GPUs, for inference tasks associated with the LLMs, wherein the resource allocation is dynamically adjusted to meet active workload demands;
monitor and analyze real-time traffic patterns and historical usage data using a traffic analyzer to predict demand for specific LLMs;
trigger the preloading of high-demand models into Hot Storage or Warm Storage tiers based on the predictions to minimize cold-start latency;
assign GPU resources dynamically to active inference tasks based on model priorities and real-time demand, and deallocate GPU resources from idle or low-priority tasks to reduce idle GPU time and optimize resource utilization;
demote models from higher-tier storage to lower-tier storage based on predefined inactivity thresholds, ensuring optimal utilization of high-speed storage by freeing up space for active or high-priority models; and
remove unused models periodically from storage tiers using a clean-up agent to free up space for new models, ensuring sustained operational efficiency.
